(19) United States
(12) Patent Application Publication
(10) Pub. No.: US 2026/0235922 A1
(43) Pub. Date: Aug. 13, 2026

(54) SYSTEM AND METHOD FOR GENERATING ENTANGLED PHOTONS

(71) Applicant: Ramot at Tel-Aviv University Ltd., Tel-Aviv (IL)

(72) Inventors: Muhammad EREW, Tel Aviv (IL); Yuval RECHES, Tel Aviv (IL); Haim SUCHOWSKI, Tel Aviv (IL)

(73) Assignee: Ramot at Tel-Aviv University Ltd., Tel-Aviv (IL)

(21) Appl. No.: 19/151,319

(22) PCT Filed: Jan. 26, 2024
(86) PCT No.: PCT/IL2024/050109

§ 371 Date: Jul. 27, 2025

Related U.S. Application Data
(60) Provisional application No. 63/441,458, filed on Jan. 27, 2023.

(51) Int. Cl. G02F 1/35; G02F 1/355

(52) U.S. Cl. CPC G02F 1/3548; G02F 1/3558

(57) ABSTRACT

A nonlinear crystal comprises a plurality of segments arranged along an axis, each segment being characterized by a parameter triplet comprising, a mismatch parameter, a coupling parameter, and a length of the segment, wherein an ordered multiplication of SU(1,1) matrices, each corresponding to one of the segment and being composed of hyperbolic or harmonic functions of a respective parameter triplet defines an overall SU(1,1) matrix describing sequential production of pairs of entangled photons along the axis from an incoming pump beam.

### RELATED APPLICATION

This application claims the benefit of priority of U.S. Provisional Patent Application No. 63/441,458 filed on Jan. 27, 2023, the contents of which are incorporated herein by reference in their entirety.

### FIELD AND BACKGROUND OF THE INVENTION

The present invention, in some embodiments thereof, relates to optics and, more particularly, but not exclusively, to a system and method for generating entangled photons. Some embodiments of the present invention utilize a crystal having a set of detuning modulated composite segments for generating the entangled photons.

Spontaneous Parametric Down-Conversion (SPDC) is a non-linear optical phenomenon where a photon spontaneously splits into two other photons of lower energies. SPDC is useful in many quantum optics applications because it serves as a resource for quantum entanglement. Such applications include quantum cryptography, quantum simulations, and quantum metrology.

A composite pulse (CP) is a series of pulses with specifically chosen phases, which emulates the effect of a simple pulse. Historically, CPs were introduced to emulate the effect of simple radiofrequency pulses in the field of magnetic resonance, and were found to be successful in reducing the effects of imperfections such as off-resonance effects. Recently, CP schemes were adopted from magnetic resonance to the realm of nonlinear optics (NLO) [1-3].

### SUMMARY OF THE INVENTION

According to an aspect of some embodiments of the present invention there is provided a nonlinear crystal for generating pairs of entangled photons from a pump photon having a pump intensity. The crystal comprises a plurality of segments arranged along an axis, each segment being characterized by a parameter triplet comprising, a mismatch parameter, Δk, a coupling parameter, κ, and a length, z, of the segment, wherein an ordered multiplication of SU(1,1) matrices, each corresponding to one of the segment and being composed of hyperbolic or harmonic functions of a respective parameter triplet, defines an overall SU(1,1) matrix describing sequential production of the pairs of entangled photons along the axis.

According to some embodiments of the invention the nonlinear crystal wherein each element of the overall SU(1,1) matrix has at least a first order variation less than a predetermined threshold.

According to some embodiments of the invention an absolute value of each element of the overall SU(1,1) matrix has n-order variations less than a predetermined threshold, for any integer n up to M, wherein M is at least 2 at least 3 or at least 4 or at least 5 or more.

According to an aspect of some embodiments of the present invention there is provided a nonlinear crystal for generating pairs of entangled photons. The crystal comprises a plurality of segments arranged along an axis such that a phase mismatch Δk is substantially piecewise constant as a function of a position along the axis.

According to some embodiments of the invention at least one of the segments is poled with a poling period selected based on the mismatch parameter.

According to some embodiments of the invention a domain size of the poled segment is an integer multiplication of a predetermined minimal domain size parameter.

According to some embodiments of the invention the minimal domain size parameter is from about 1 nm to about 100 nm, e.g., about 25 nm.

According to some embodiments of the invention each of at least two of the segments is made of more than one material selected to ensure a phase-mismatch between adjacent segments.

According to some embodiments of the invention at least two of the segments are maintained at different temperatures selected to ensure a phase-mismatch between adjacent segments.

According to some embodiments of the invention a length of each segment is at least 1000 nm or at least 1500 nm.

According to some embodiments of the invention the mismatch parameters of the segments form an antisymmetric sequence of mismatch parameters.

According to some embodiments of the invention the mismatch parameters of the segments from an interleaved sequence of mismatch parameters.

According to some embodiments of the invention adjacent mismatch parameters of the interleaved sequence are opposite in sign.

According to some embodiments of the invention adjacent mismatch parameters of at least two of the interleaved sequence are equal in sign but not in magnitude.

According to some embodiments of the invention each odd index element of the interleaved sequence is equal in magnitude and opposite in sign to an even index element immediately following the odd index element.

According to some embodiments of the invention for each of the segments, the mismatch parameter and the coupling parameter are selected such that a respective SU(1,1) matrix is composed of harmonic functions of a respective parameter triplet.

According to some embodiments of the invention an overall efficiency of the production of the pairs is at most 50% or at most 40% or at most 30% of an efficiency of producing pairs of entangled photons from a perfectly phase matched nonlinear crystal having the same length as the nonlinear crystal and using the pump intensity.

According to an aspect of some embodiments of the present invention there is provided a method of generating pairs of entangled photons, comprising directing a beam of pump photons having a pump intensity onto the nonlinear crystal as delineated above and optionally and preferably as further detailed below.

According to an aspect of some embodiments of the present invention there is provided a light emission system that comprises the nonlinear crystal as delineated above and optionally and preferably as further detailed below.

According to an aspect of some embodiments of the present invention there is provided a communication system that comprises the nonlinear crystal as delineated above and optionally and preferably as further detailed below.

According to an aspect of some embodiments of the present invention there is provided a quantum teleportation system that comprises the nonlinear crystal as delineated above and optionally and preferably as further detailed below.

According to an aspect of some embodiments of the present invention there is provided a quantum cryptography system that comprises the nonlinear crystal as delineated above and optionally and preferably as further detailed below.

According to an aspect of some embodiments of the present invention there is provided a quantum computer that comprises the nonlinear crystal as delineated above and optionally and preferably as further detailed below.

According to an aspect of some embodiments of the present invention there is provided a quantum metrology inspection system that comprises the nonlinear crystal as delineated above and optionally and preferably as further detailed below.

According to an aspect of some embodiments of the present invention there is provided a quantum simulation system that comprises the nonlinear crystal as delineated above and optionally and preferably as further detailed below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a SPDC process in different wavelengths and directions, according to some embodiments of the present invention.

FIGS. 2A-C show a sensitivity of a wavenumber difference Δk for variations in a wavelength λ (FIG. 2A), an angle of incidence θₛ (FIG. 2B), and a temperature T (FIG. 2C), as obtained by calculations performed according to some embodiments of the present invention.

FIG. 2D shows counts per seconds of generated entangles pairs as a function of a wavenumber difference Δk for a perfectly phase matched KTP crystal of length 20 mm, as obtained by calculations performed according to some embodiments of the present invention.

FIG. 2E is a two-dimensional color coded map showing a dependence of a wavenumber difference Δk on the temperature T and angle of incidence θₛ for a constant value of a wavelength λₛ (1064 nm in this example), as obtained by calculations performed according to some embodiments of the present invention. Shown on the maps are curves corresponding to Δk=0, for which the rate is at its maximal value, Δk=±55.9 m⁻¹, for which the rate is 90% of its maximal value, Δk=±139.4 m⁻¹, for which the rate is 50% of its maximal value, and Δk=±313.8 m⁻¹, for which the rate is zero.

FIG. 3 is a schematic illustration of a composite crystal for robust SPDC and OPA, according to some embodiments of the present invention.

FIGS. 4A-C are schematic illustrations of crystals of different types of poling schemes, including a periodically poled crystal (FIG. 4A), a quasi-phase-matched poled crystal (FIG. 4B), and a composite poling crystal (FIG. 4C), according to some embodiments of the present invention.

FIGS. 5A-H show the number of generated entangled pairs per second as a function of the temperature for several DMCS designs as obtained in calculations performed according to some embodiments of the present invention. Lines of the maximum values and 90% thereof are added in each graph, demonstrating robustness.

FIGS. 6A-H show the number of generated entangled pairs for a perfectly phase matched crystal (denoted PPM in FIGS. 6A-H) with the same total length as the respective DMCS designs.

FIGS. 7A-I are two-dimensional color coded maps showing numbers of generated entangled pairs per second as a function of deviations from a temperature of 37° C. and a zero angle of incidence θₛ for a perfectly phase matched crystal of length 20 mm (FIG. 7A), and DMCS crystals, listed in Table 1, below, and enumerated I, II, III, IV, V, VI, VII, and VIII (FIGS. 7B-I) respectively.

FIGS. 8A-I show numbers of generated entangled pairs per second as a function of temperature deviation from 37° C. at zero angle of incidence for 20 different incident powers of the pump, for a perfectly phase matched crystal of length 20 mm (FIG. 8A), and DMCS crystals, listed in Table 1, below, and enumerated I, II, III, IV, V, VI, VII, and VIII (FIGS. 8B-I) respectively.

$$\frac{δ {P}_{pump}}{{P}_{pump}}$$

from up to down in each of the graphs is +1 down to −0.9 in jumps of −0.1. The robustness of the process does not change under deviations in the incident pump's intensity.

FIGS. 9A-I are two-dimensional color coded maps showing numbers of generated entangled pairs per second as a function of deviations from a temperature of 37° C. and a zero angle of incidence, as calculated with the semi-classical simulations for a perfectly phase matched crystal of length 20 mm (FIG. 7A), and DMCS crystals, listed in Table 1, below, and enumerated I, II, III, IV, V, VI, VII, and VIII (FIGS. 7B-I) respectively.

FIGS. 10A-I show numbers of generated entangled pairs per second as a function of the temperature for each DMCS design at a colinear setup and at the designated wavelength of 1064 nm.

FIGS. 11A-H show numerical derivatives as calculated for different numerical windows.

FIGS. 12A-B are two-dimensional color coded maps showing numbers of generated entangled pairs per second as a function of deviations from a temperature of 37° C. and a zero angle of incidence, as calculated for bulk QPM periodically poled (PP) Type-0 SPDC, for wavelength conversion of 532 nm to 1064 nm.

FIGS. 12C-D are two-dimensional color coded maps showing numbers of generated entangled pairs per second as a function of deviations from a temperature of 37° C. and a zero angle of incidence, as calculated for bulk QPM Composite-Poling colinear Type-0 SPDC, for wavelength conversion of 532 nm to 1064 nm.

FIGS. 13A-B show a comparison of a periodic poling crystal to a composite-poling crystal according to some embodiments of the present invention, where FIG. 13B shows normalized values for the counts shown in FIG. 13A.

FIG. 14 shows a comparison of composite-poling crystal according to some embodiments of the present invention and a periodic poling design with a length selected such that output power is same at peak.

FIGS. 15A-D show numbers of generated entangled pairs per second as a function of deviations from a temperature of 37° C. for colinear type 2 composite-poling SPDC and for wavelength conversion of 405 nm to 810 nm.

FIG. 16 is a schematic illustration of an experimental setup used in experiments performed according to some embodiments of the present invention.

FIG. 17A shows experiment results (crosses) and simulation results (lines) of periodic poling and composite poling designs for colinear type-0 SPDC and for wavelength conversion of 532 nm to 1064 nm.

FIGS. 17B-E are two-dimensional color coded maps showing numbers of generated entangled pairs per second as a function of deviation from a temperature of 37° C. and a wavelength (FIGS. 17B, 17D), and as a function of deviations from a temperature of 37° C. and a zero angle of incidence (FIGS. 17C, 17E), as calculated for bulk QPM Composite-Poling colinear Type-0 SPDC, for wavelength conversion of 532 nm to 1064 nm.

FIGS. 18A and 18B show count-rate as a function of the temperature with different input pump power for a composite-poling crystal according to some embodiments of the present invention.

FIG. 19 shows a fit to measurements performed to a periodically poled crystal.

FIGS. 20A-D show count rate as a function of the temperature for different pump power for DMCS crystals, listed in Table 1, below, and enumerated II, IV, VI, and VIII, respectively, demonstration of linearity of the count rate with respect to the pump power.

FIGS. 21A and 21B are two-dimensional color coded maps showing numbers of generated entangled pairs per second obtained using a trapezoid poled waveguide as a function of deviation from the waveguide's wall angle and width, for a type-2 SPDC and for wavelength conversion of 785 nm to 1570 nm. FIG. 21A depicts the generation from a periodically poled crystal and FIG. 21B depicts the generation in a waveguide that is poled according to crystal VI as listed in Table 1, below.

FIGS. 22A-B show simulation (FIG. 22B) and measurement (FIG. 22A) for a composite-poling crystal of the present embodiments, where the parameters of the composite-poling crystal are listed in Table 1, below, crystal II.

FIGS. 23A-B show simulation (FIG. 23B) and measurement (FIG. 23A) for a composite-poling crystal of the present embodiments, where the parameters of the composite-poling crystal are listed in Table 1, below, crystal IV.

FIGS. 24A-B show simulation (FIG. 24B) and measurement (FIG. 24A) for a composite-poling crystal of the present embodiments, where the parameters of the composite-poling crystal are listed in Table 1, below, crystal VI.

FIGS. 25A-B show simulation (FIG. 25B) and measurement (FIG. 25A) for a composite-poling crystal of the present embodiments, where the parameters of the composite-poling crystal are listed in Table 1, below, crystal VIII.

### DESCRIPTION OF SPECIFIC EMBODIMENTS OF THE INVENTION

The present invention, in some embodiments thereof, relates to optics and, more particularly, but not exclusively, to a system and method for generating entangled photons. Some embodiments of the present invention utilize a crystal having a set of detuning modulated composite segments for generating the entangled photons.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Conventional nonlinear crystals for producing quantum entangled photons are sensitive to variation in temperature, and the parameters of the pump beam such as the incident angle, wavelength, and intensity, and are also sensitive to fabrication errors. The inventors have devised a nonlinear crystal, having a reduced sensitivity to one or more of these parameters and optionally and preferably reduced sensitivity to fabrication errors.

Referring now to the drawings, FIG. 4C is a schematic illustration of a nonlinear crystal 10 for generating pairs 14a, 14b of photons from a pump photon 12 according to some embodiments of the present invention. The angular frequency of the pump photon 12 is denoted ωₚ, and the angular frequencies of photons 14a and 14b are denoted ωₛ and ωᵢ, respectively. Photons 14a and 14b have entangled quantum mechanical states, and are therefore referred to as entangled photons. The frequencies ωₚ, ωₛ, and ωᵢ satisfy: ωₚ=ωₛ+ωᵢ. Typically, but not necessarily, the wavelength of the pump photon is from about 400 nm to about 800 nm. Typically, but not necessarily, the wavelengths of photons 14a and 14b equal to each other.

As used herein “entangled quantum mechanical states of a pair of photons” refers to quantum mechanical states that are described by sets of quantum numbers in a manner that the sets are correlated to each other so that any change in one of the sets causes a corresponding change in the other set.

It is convenient to refer to one of the entangled photons, e.g., photon 14a, as “a signal photon,” and to the other one of the entangled photons, e.g., photon 14b, as “an idler photon.”

Preferably, crystal 10 is designed and constructed for a specific range of photon intensities or amplitudes of pump photon 12. Preferably, crystal 10 is also designed and constructed for expected wavenumbers of the pump, signal and idler photons.

Crystal 10 comprises a plurality of segments 16a, 16b, 16c, arranged along an axis 18 (shown separately, for clarity of presentation). Typically, the length l₁, l₂, l₃, . . . , of each of the segments 16 is at least 500 nm or at least 600 nm or at least 700 nm or at least 800 nm or at least 900 nm or at least 1000 nm or at least 1100 nm or at least 1200 nm or at least 1300 nm or at least 1400 nm or at least 1500 nm. The total length of crystal 10 optionally and preferably equals the sum of lengths of all the segments 16.

While FIG. 4C shows three segments, it is to be understood that crystal can have any number larger than 1 of segments. Each of segments 16a, 16b, 16c, is optionally and preferably poled to exhibit a periodic structure of alternating domains 20 with reversed polarization. This can be achieved using techniques such as, but not limited to, electric field poling or quasi-phase matching (QPM). In FIG. 4C, the domains 20 alternate with poling periods Λ₁, Λ₂, and Λ₃, for segments 16a, 16b, 16c, respectively. Preferably, the period remains constant throughout the segment.

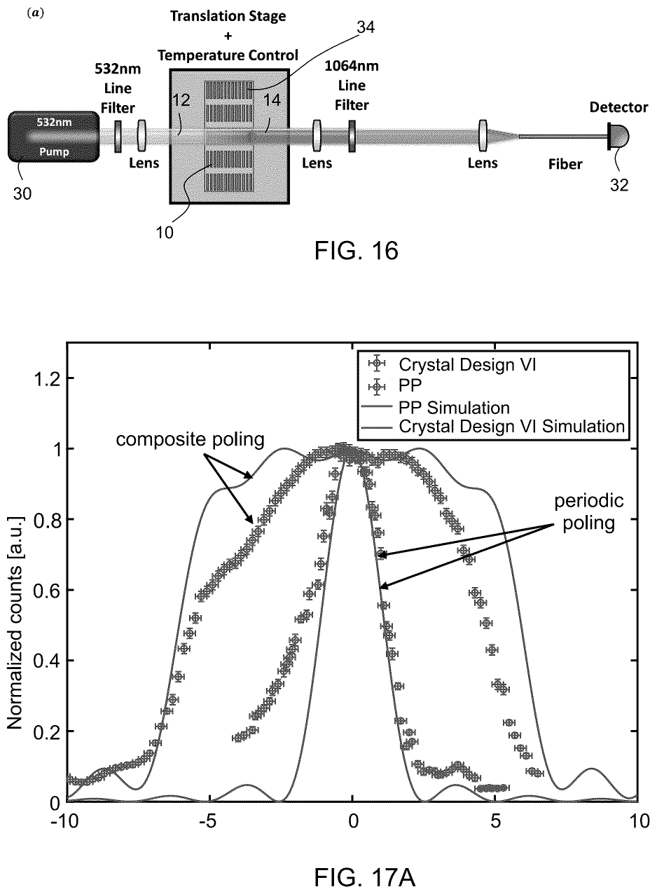

In use, a pump optical field impinges on one side of crystal 10 (the left side, in FIG. 4C), and interacts with the domains of the first segment (segment 16a in FIG. 4C). The pump optical field is typically a pump light beam containing a multiplicity of pump photons 12. As a result of the interaction between the pump optical field and the first segment, one or more pairs of entangled photons are produced. The pair, as well as remnant photons in the pump optical filed may propagate through the other segments and so this production continues sequentially, generating additional pairs 14a and 14b until at least some of the produced pairs exit crystal 10 from the opposite side (the right side in FIG. 4C). A typical system for generating entangled photons using crystal 10 is illustrated in FIG. 16, showing a light source 30 directing a pump light beam containing pump photon 12 to crystal 10, wherein crystal 10 generates entangled photons 14a and 14b (designated collectively as 14), which can be detected by means of a detector 32. The pump field can be directed to crystal 10 either in free space or through a waveguide.

Preferably, the overall efficiency of the production of the pairs is at most 50% or at most 40% or at most 30% of an efficiency of producing pairs of entangled photons from a perfectly phase matched nonlinear crystal having the same length as nonlinear crystal 10 and using the same pump intensity.

Each segments of crystal 10 is different from its neighbor segments so that during the propagation of the optical field from one segment to the other it experiences different levels of interaction with the crystal. The segments of crystal 10 differ from each other in that each segment 16 is characterized by a specific parameter triplet (Δk, κ, z), where Δk is a mismatch parameter representing a phase mismatch, K is a coupling parameter, and z is the length of the respective segment along the axis 18. The parameters in the triplet (Δk, κ, z) can be selected independently or they can be selected according to a predetermined relation, wherein the value or values of one or two of the parameters in the triplet for a particular segment is/are selected according to an optimization scheme, and the value or values of the other parameter(s) are/is set by the predetermined relation without performing further optimization. In some embodiments of the present invention the coupling parameter κ is proportional, more preferably linearly proportional, to a representative value (e.g., average, median) Aₚ of the range of photon amplitudes of the pump optical field. For example, κ can be set to be κ=−Aₚ(2χ⁽²⁾/πℏc)\sqrt{ωₛωᵢωₚ/nₛnᵢnₚ}, where χ⁽²⁾ is an effective second-order susceptibility, nₛ, nᵢ and nₚ are the refractive indices of crystal 10 for the signal, idler and pump photons, respectively, and c is the speed of light in vacuum. A representative example of a relation among the parameters in the triplet (Δk, κ, z) is provided in the Examples section that follows (see EQ. 20).

Preferably, at least one of segments 16 is poled with a poling period selected based on the respective mismatch parameter Δk. A representative relation between the poling periods, the mismatch parameter and the expected wavenumbers of the pump, signal and idler photons is provided in the Examples section that follows (see, e.g., EQ. 2).

In embodiments in which the period remains constant throughout the segment, the mismatch parameter Δk is substantially piecewise constant as a function of a position along axis 18.

As used herein “piecewise constant function” means a function that is constant over certain intervals or pieces of the function's domain. In the context of crystal 10, the Δk is substantially piecewise constant in that for each segment, the value of Δk is constant or does not substantially vary (e.g., vary by less than 20 m⁻¹ or less than 10 m⁻¹ or less than 5 m⁻¹) throughout the segment, and in that adjacent segments have different values of Δk.

In some embodiments of the present invention the domain size of one or more of the poled segments is an integer multiplication of a predetermined minimal domain size parameter. A typical value for the minimal domain size parameter is from about 1 nm to about 100 nm, e.g., about 25 nm.

Preferably two or more of the segments 16 are constructed to ensure that there is a phase mismatch between adjacent segments. This can be ensured in more than one way. In some embodiments of the present invention at least two of segments 16, more preferably each of segments 16, is made of more than one material selected to ensure a phase-mismatch between adjacent segments. In some embodiments of the present invention at least two of segments 16 are maintained at different temperatures selected to ensure a phase-mismatch between adjacent segments.

In some embodiments of the present invention the mismatch parameters Δk of the segments 16 form an antisymmetric sequence of mismatch parameters. For example, the mismatch parameters of the first and last segments can have the same value, but opposite sign, the mismatch parameters of the second and penultimate segments can have the same value, but opposite sign, and so on.

In alternative embodiments the mismatch parameters of segments 16 from an interleaved sequence of mismatch parameters. In these embodiments, the odd index elements of the interleaved sequence form one sequence and the even index elements of the interleaved sequence form another sequence. For example, the odd index elements of the interleaved sequence can all be positive and the even index elements of the interleaved sequence can all be negative. In some embodiments of the present invention each odd index element of the interleaved sequence is equal in magnitude and opposite in sign to an even index element immediately following that odd index element. Specifically, the first segment (segment 16a in FIG. 4C) can have a certain value Δk₁ of the mismatch parameter, the second segment (segment 16b in FIG. 4C) can have an opposite value −Δk₁ for the mismatch parameter, the next segment can have a different value Δk₂ for the mismatch parameter, the next segment can have an opposite value −Δk₂ and so on.

In some embodiments of the present invention, the number of segments in crystal 10 and the relations among the values of the mismatch parameters of segments 16 is set according to one of EQs. 19 and 21, below, the relation between the parameters of the triplet Δk, κ, z for each of segments 16 are set according to EQ. 20, below, and the values of the mismatch parameters and the total length of crystal 10 are within 10% of the values listed for one of crystals I through VIII listed in Table 1, below.

The triplet of each segment 16 can be used for calculating a transformation matrix which provide the amplitudes of the signal and idler photons after they propagate through all the domains that form the segment, for a given pair of amplitudes of these photons at the points of incidence with the first domain of the segment. In various exemplary embodiments of the invention the transformation matrix is an SU(1,1) matrix.

An SU(1,1) is any matrix of the form:

$$( \begin{matrix}α & β \\ β * & α *\end{matrix} )$$

where α and β are complex numbers satisfying |α|²−|β²|=1, and where α* and β* are the complex conjugates of α and β, respectively.

When the transformation matrix is an SU(1,1) matrix, the matrix elements of the transformation matrix of each segment can be calculated using hyperbolic or harmonic functions of combination of parameters of the parameter triplet Δk, κ, z, of the respective segment.

A hyperbolic function include one or more of hyperbolic cosine function, hyperbolic sine function, hyperbolic tangent function, hyperbolic cotangent function, hyperbolic secant function, and hyperbolic cosecant function. A harmonic function include one or more of cosine function, sine function, tangent function, cotangent function, secant function, and cosecant function.

It is appreciated that under some conditions, a hyperbolic function can coincide with a harmonic function. For example, when the argument of a hyperbolic cosine function is imaginary, the hyperbolic cosine function coincide with a cosine function. Thus, in some embodiments of the present invention for each of segments 16, the mismatch parameter Δk and the coupling parameter κ are selected such that the respective SU(1,1) matrix is composed of harmonic functions of the respective parameter triplet.

Representative examples of combinations of combination of parameters of the parameter triplet and their use with hyperbolic or harmonic functions for constructing the transformation matrix of each segment are provided in the Examples section that follows. An ordered multiplication of all the SU(1,1) matrices that respectively correspond to all the segments 16 defines an overall SU(1,1) matrix that describes the sequential production of all the pairs of entangled photons along the axis 18. In other words, crystal 10 effects a conversion of pump optical field into pairs of entangled photons, which can be measured, and the overall SU(1,1) matrix describes this conversion so that when the overall SU(1,1) matrix multiplies a vector formed by the amplitudes of the produced pairs at the entry point of the crystal, the result of this multiplication is a vector formed by the amplitudes of the produced pairs exiting the crystal.

In some embodiments of the present invention an absolute value of each element of the overall SU(1,1) matrix (α, β, α*, and β*, in the above example) has at least a first order variation less than a predetermined threshold. Typically the predetermined threshold is less than 0.1 or less than 0.01, or less than 0.001. This can be conveniently ensured by applying an optimization scheme in which an error ε is defined for the mismatch parameters Δk, a first order derivative of |β|² with respect to ε is calculated at ε=0, and the parameter triplets is selected such that this derivative is less than the predetermined threshold or zero. Preferably, the absolute value of each element of the overall SU(1,1) matrix has also a second order variation less than the predetermined threshold. This can be conveniently ensured by applying an optimization scheme in which a second order derivative of |β|² with respect to ε at ε=0 is also calculated, and the parameter triplets is selected such that this derivative is also less than the predetermined threshold or zero.

More preferably, each of the first nth-order variations of the absolute value of each element of the overall SU(1,1) matrix is less than the predetermined threshold. This can be conveniently ensured by applying an optimization scheme in which the first n-order derivatives of |β|² with respect to ε are calculated at ε=0, and the parameter triplets is selected such that each of these derivatives is less than the predetermined threshold or zero. In some embodiments of the present invention n is less than M, wherein M is at least 3 or at least 4 or at least 5.

Crystal 10 can be used in any optical or optoelectronic scenarios where the utilization of entangled photons would be advantageous. Representative examples of systems that can comprise crystal 10, including, without limitation, a light emission system, a communication system, a quantum teleportation system, a quantum cryptography system, a quantum computer, a quantum metrology inspection system, and a quantum simulation system.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Detuning Modulated Composite Segments for Robust Generation of Entangled Photons

### Introduction

SPDC is a non-linear optical process where a photon spontaneously splits into two other photons of lower energies. SPDC is today at the heart of many quantum optics experiments, serving as a quantum entanglement resource. Among its uses are applications in quantum cryptography, quantum simulations, quantum metrology and testing fundamental physics laws in quantum mechanics. The Inventors found that current nonlinear crystal designs are very sensitive to temperature variation of the nonlinear crystal, fabrication errors, changes in the incident angle between the light and the crystal, and to variation of the pump's wavelength and intensity. The Inventors found that current pair generation methods, and specifically the SPDC process, suffer from high sensitivity to the setup parameters. The Inventors also found that high rates of high-order pair generation processes can temper the usability of the source to quantum applications. Such undesired multi-pair generation may limit the used pump intensity to lower values.

CPs are historically a series of pulses with specifically chosen phases to enable complete population inversion in nuclear magnetic resonance (NMR) experiments. CPs are currently used in many control schemes for a variety of physical systems. These include atomic systems, trapped ions and matching high harmonic generation in nonlinear optics. Recently, CP schemes were adopted from NMR to the realm of NLO. Works by Rangelov et al. [1] and Erlich et al. [2] showed numerically and experimentally that a novel method using a CS crystal design based on the NMR composite pulses scheme of Shaka and Pines [3] can be used in NLO to create a broadband and robust second harmonic generation (SHG) process. The CS design was shown to have shorter interaction length and to require lower input intensities than adiabatic schemes, thus allowing an intermediate solution of broadband and robust conversion solution compared to perfect phase-matching, while maintaining a shorter crystal and lower pump intensity than the adiabatic chirped solution.

Al-Mahmoud et al. [4] showed numerically that the Shaka-Pines schemes can be adopted for a robust high-gain optical parametric amplification (OPA) process. Recently Kyoseva et al. [5] suggested a high-fidelity universal CP scheme that was later demonstrated in a coupled waveguides system [6]. Sum frequency generation (SFG) using CP was shown by Reches et al.

The Inventors devised a technique that performs a robust pair generation while maintaining a relatively low rate of high-order pair generation. The technique employs detuning-modulated composite segments (DMCS) that utilize the off-resonant detuning as a control parameter to create a composite N-step evolution of the conversion process. The inventors found that DMCS schemes are useful for nonlinear quasi-phase-matching (QPM) crystals because they are robust to errors in many system parameters, such as coupling, phase-mismatch (also known as “detuning”), pulse area, temperature, and input and output angles. Therefore, this technique is advantageous for the fabrication of QPM crystals, which are prone to inevitable fabrication errors and might experience different environmental and setup conditions. In the QPM crystal realization, the above system parameters translate to poling period, pump intensity, segment's length, temperature, and input and output signals angles.

The DMCS intentionally uses off-resonance poling schemes to allow robust state transfer with a predetermined high-order pair generation rate, at the expanse of the number of generated pairs for a given input power. This allows robust SPDC and OPA processes. The solution of the present embodiments is robust to various system parameters, such as coupling, detuning and sequence length. This technique is suitable for, but is not limited to, implementation in QPM crystals, which are considered a standard component for pair generation via the SPDC process.

### Generating Entangled Photons Via SPDC

Entangled photon pairs are useful in many applications, including, without limitation, quantum computation, quantum communication, quantum cryptography, quantum imaging, quantum spectroscopy, quantum metrology, etc. This is due to the enormous variety of counterintuitive effects resulting from the non-classical strong correlations implied by entanglement.

In SPDC is a nonlinear process in which a high-energy photon (called the pump) interacting with a second-order nonlinear material or crystal, is spontaneously down-converted into two lower-energy photons (called the signal and the idler), where the pump, the signal, and the idler fulfill the energy conservation and phase-matching (momentum conservation) conditions. The attributes of the nonlinear crystal and the pump beam are selected to provide photon states with properties fitted to specific needs.

A typical setup that generates an efficient SPDC process can be built by using a relatively weak continuous-wave (CW) laser (e.g., in the range of 1-1000 mW) and creating phase matching condition by impinging it onto a nonlinear crystal designed for quasi phase matching or angle phase matching or birefringent phase matching or temperature based phase matching or any other phase matching method. Typical materials that are used to create such crystals are LiNbO₃, Stoichiometric Lithium Tantalate (SLT), potassium titanyl phosphate (KTP), and beta barium borate (BBO). Such setups can be used to generate two entangled single-photon beams due to the low power of the pump laser. Two parameters that characterize such systems are the pair-generation rate, defined as the number of entangled pairs per second that are generated, and the multi-pair-generation rate, defined as the rate of parasitic processes that create more than one pair of entangled photons at once. The creation of more than one entangled pair at once can reduce the interference visibility of the beams (a measure of their entanglement) and interfere with their later uses that rely on the entanglement between them.

SPDC begins from the vacuum state of the signal and the idler. The pump's intensity is much stronger than the signal and the idler, such that it approximately does not change along the propagation in the crystal, leading to a classical process of OPA. Thus, the dynamics of the amplitudes of the classical waves are similar to those of the expectation values of the suitable creation and annihilation operators of the suitable photons. SPDC and OPA thus share the same dynamical behavior, and obey an SU (1,1) symmetry.

The production of pairs of entangled photons via SPDC is sensitive to the process's parameters, which may, for example, impose a limitation on the wavelength bandwidth or temperature of the process. This is mainly caused by the material dispersion and the phase matching condition for a single triplet of wavelengths. A change in wavelength or temperature breaks the phase-matching condition, and a change in the input intensity modifies the coupling coefficient. As a result, conventional nonlinear crystals for the creation of SPDC are very sensitive to temperature variations, fabrication errors, changes in the incident angle between the light and the crystal, and to variations of the pump's wavelength and intensity. Known in the art [12, 13, 14, 15, 16], are chirped schemes, which provide less sensitive SPDC but these schemes require a relatively high intensity of the incident pump or very long interaction length. Such an intensity may damage the nonlinear crystal itself and may raise the rate of unwanted multi-pair generation processes. Chirped schemes also require a relatively long crystal, long interaction length, and long Rayleigh range.

The solution of the trilinear Hamiltonian of SPDC under the approximation of an un-depleted pump, and for a sufficiently short crystal that preserves the undepletion assumption, describes a hyperbolic or exponential SU (1,1) dynamics. The hyperbolic solution can be harmonic if the argument is imaginary, which can be achieved by a sufficiently large momentum mismatch of the crystal for a desired process. This regime, which also describes SU (1,1) dynamics provides a wide domain of robustness of SPDC and OPA, as further detailed below.

### The Theory of SPDC

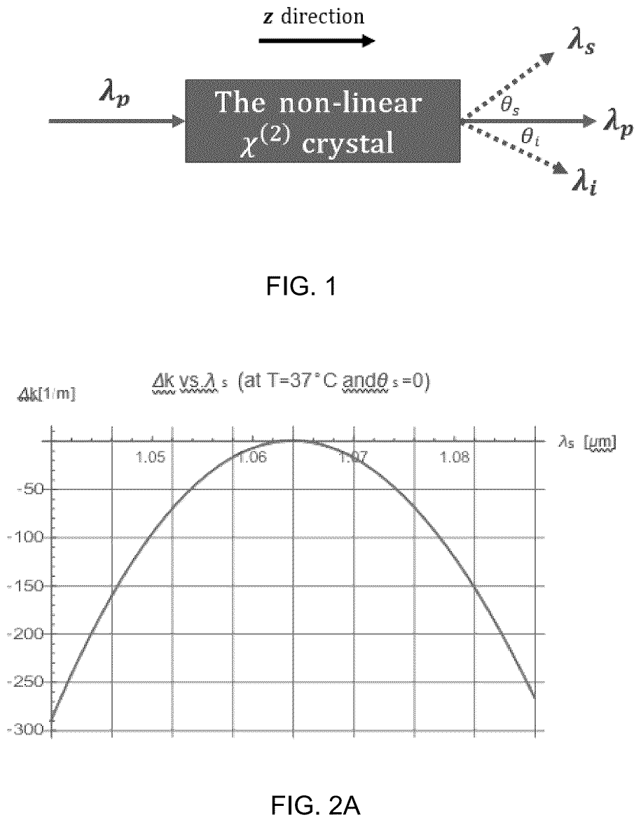

Consider the z-dependent three-wave mixing Hamiltonian of SPDC in a χ⁽²⁾ crystal in the slowly varying envelope approximation for specific wavelengths of the signal-idler-pump plane-wave photons and specific directions of propagation (see FIG. 1) [18, 17]:

$$ℋ ( z ) = ℏ {ω}_{s} {a}_{s}^{†} {a}_{s} + ℏ {ω}_{i} {a}_{i}^{†} {a}_{i} + ℏ {ω}_{p} {α}_{p}^{†} {a}_{p} + ℏ \overline{κ} {e}^{- i Δ kz} {a}_{s}^{†} {a}_{i}^{†} {a}_{p} + ℏ \overline{κ} {e}^{i Δ kz} {a}_{s} {a}_{i} {a}_{p}^{†} , \qquad ( 1 )$$

where ωₛ, ωᵢ and ωₚ are the signal, idler and pump frequencies respectively, ωₚ=ωₛ+ωᵢ, z is the position along the propagation axis, κ̅ is a real constant and Δk is the phase mismatch parameter that contains the mismatch compensation term associated with the periodic grating:

$$Δ k = \vert Δ \vec{k} \vert = ( {\vec{k}}_{s} + {\vec{k}}_{i} - {\vec{k}}_{p} ) \cdot \hat{z} - \frac{2 π}{Λ ( z )} , \qquad ( 2 )$$

where

$$\vert {\vec{k}}_{j} \vert ≡ \frac{2 π}{{λ}_{j}} {n}_{T} ( {λ}_{j} , {θ}_{j}^{′} ) ( j = s , i , p )$$

are the wave vectors, n_{T}(λⱼ,θ′ⱼ) (j=s,i,p) are the refractive indices of the crystal for the wavelengths λⱼ propagating in the δ′ⱼ directions (inside the crystal) at temperature T, and Λ is the QPM period, that is, the first-order local poling period in the case of periodically poled crystals. θ_{j′} and θⱼ satisfy Snell's law:

$${n}_{T} ( {λ}_{j} , {θ}_{j}^{′} ) sin {θ}_{j}^{′} = sin {θ}_{j} , \qquad ( 3 )$$

and we assume the crystal has an axis of symmetry which is the direction of the incident pump, such that in the perpendicular plane, the electric susceptibility tensor is isotropic. The classical treatment of OPA gives the effective nonlinear coupling coefficient for first-order QPM:

$$ℏκ = - \frac{2 {χ}^{( 2 )}}{π c} \sqrt{\frac{{ω}_{s} {ω}_{i} {ω}_{p}}{{n}_{s} {n}_{i} {n}_{p}}} ,$$

where χ⁽²⁾ is the effective second-order susceptibility, nₛ, nᵢ and nₚ are the refractive indices of the crystal for the signal, idler and pump, and c is the speed of light in vacuum.

The Heisenberg equations of motion of the operators are

$${\partial }_{z} {a}_{s} ( z ) = - i {ω}_{s} {a}_{s} ( z ) - i \overline{κ} {e}^{- i Δ kz} {a}_{i}^{†} ( z ) {a}_{p} ( z ) , \qquad ( 4 a )$$

$${\partial }_{z} {a}_{i} ( z ) = - i {ω}_{i} {a}_{i} ( z ) - i \overline{κ} {e}^{- i Δ kz} {a}_{s}^{†} ( z ) {a}_{p} ( z ) , \qquad ( 4 b )$$

$${\partial }_{z} {a}_{p} ( z ) = - i {ω}_{p} {a}_{p} ( z ) - i \overline{κ} {e}^{i Δ kz} {a}_{s} ( z ) {a}_{i} ( z ) , \qquad ( 4 c )$$

and defining aⱼ(z)≡e^{-iω}^{ⱼ}^{t}bⱼ(z) (for j=s,i,p) the equations are simpler:

$${\partial }_{z} {b}_{s} ( z ) = - i \overline{κ} {e}^{- i Δ kz} {b}_{i}^{†} ( z ) {b}_{p} ( z ) , \qquad ( 5 a )$$

$${\partial }_{z} {b}_{i} ( z ) = - i \overline{κ} {e}^{- i Δ kz} {b}_{s}^{†} ( z ) {b}_{p} ( z ) , \qquad ( 5 b )$$

$${\partial }_{z} {b}_{p} ( z ) = - i \overline{κ} {e}^{i Δ kz} {b}_{s} ( z ) {b}_{i} ( z ) . \qquad ( 5 c )$$

In the classical limit, one achieves the equations of motion of OPA:

$${\partial }_{z} {A}_{s} ( z ) = - i \overline{κ} {e}^{- i Δ kz} {A}_{i}^{*} ( z ) {A}_{p} ( z ) , \qquad ( 6 a )$$

$${\partial }_{z} {A}_{i} ( z ) = - i \overline{κ} {e}^{- i Δ kz} {A}_{s}^{*} ( z ) {A}_{p} ( z ) , \qquad ( 6 b )$$

$${\partial }_{z} {A}_{p} ( z ) = - i \overline{κ} {e}^{i Δ kz} {A}_{s} ( z ) {A}_{i} ( z ) , \qquad ( 6 c )$$

where

$${A}_{j} ≡ \sqrt{\frac{{n}_{j}}{{ω}_{j}}} {E}_{j} ( j = s , i , p )$$

) are now the amplitudes of the waves which are proportional to the amplitudes Eⱼ of the wave electric fields and |Λⱼ|² (j=s,i,p) are proportional to the number of associated photons.

Eq. (6) are the equations of the classical amplitudes, and their exact solution involves the Jacobi elliptic functions [19]. However, in the un-depleted pump approximation, in which the input pump propagates nearly unattenuated through the non-linear medium while the much weaker signal and idler are being built up, the differential evolution equations of the signal and the idler become:

$${\partial }_{z} {A}_{s} ( z ) = - i \overline{κ} {A}_{p} {e}^{- i Δ kz} {A}_{i}^{*} ( z ) , \qquad ( 7 a )$$

$${\partial }_{z} {A}_{i}^{*} ( z ) = i \overline{κ} {A}_{p} {e}^{i Δ kz} {A}_{s} ( z ) , \qquad ( 7 b )$$

and the SU (1, 1) dynamics of Aₛ and Aᵢ simplify and can be written as

$$( \begin{matrix}{A}_{s} ( z ) \\ {A}_{i}^{*} ( z )\end{matrix} ) = ( \begin{matrix}α & β \\ β * & α *\end{matrix} ) ( \begin{matrix}{A}_{s} ( 0 ) \\ {A}_{i}^{*} ( 0 )\end{matrix} ) , \qquad ( 8 )$$

$$where$$

$$α = {e}^{- \frac{i Δ k}{2} Z} ( cosh ( \sqrt{{κ}^{2} - {( \frac{Δ k}{2} )}^{2}} Z ) + i \frac{Δ k}{2 \sqrt{{κ}^{2} - {( \frac{Δ k}{2} )}^{2}}} sinh ( \sqrt{{κ}^{2} - {( \frac{Δ k}{2} )}^{2}} Z ) ) \qquad ( 9 a )$$

$$β = - {ie}^{\frac{i Δ k}{2} Z} \frac{κ}{\sqrt{{κ}^{2} - {( \frac{Δ k}{2} )}^{2}}} sinh ( \sqrt{{κ}^{2} - {( \frac{Δ k}{2} )}^{2}} Z ) , \qquad ( 9 b )$$

where κ≡Aₚκ̅.

Note that |α|²−|β|²=1 holds by definition. Physically, this means that the number of generated signal-idler pairs is equal to the number of annihilated pump photons. When perfect phase-matching is reached Δk=0, the number of signal-idler pairs grows exponentially from their vacuum in the un-depletion regime of the pump.

The equations of motion of the operators in the Heisenberg picture in the un-depleted regime are the same as Eq. (8) with the same entries of the transformation matrix as in Eq. (9). This implies that starting with the state |ψ(z=0) [symbol] =|nₛ=0, nᵢ=0, nₚ=N [symbol] (where N>>10⁶), the state at position z in the crystal is

$$\vert ψ ( z ) 〉 = {\sum }_{n = 0}^{∞} \frac{1}{\vert α ( z ) \vert} {( \frac{{e}^{- i {ω}_{s} t} β ( z )}{{e}^{i {ω}_{{i}^{t}}} {α}^{*} ( z )} )}^{n} , \qquad ( 10 )$$

which implies a probability of pⁿ(1−p) for n pairs of idler-signal to exist at position z in the crystal, where

$$p ≡ \frac{{\vert β ( z ) \vert}^{2}}{1 + {\vert β ( z ) \vert}^{2}} .$$

The number of expected pairs for this thermal (or geometrical) distribution is

$$μ ≡ \frac{p}{1 - p} = {\vert β ( z ) \vert}^{2}$$

and the variance is

$$\frac{p}{{( 1 - p )}^{2}} = μ ( μ + 1 ) .$$

Note that a measurement of, for example the expected value, provides the entire distribution, since it depends only on one parameter: |β(z)|².

### The Harmonic Regime

When (Δk/2)²>κ² [Eqs. (8), (9)], the hyperbolic solution becomes harmonic and the exponential behavior disappears. In this case the SPDC Hamiltonian in Eq. (1) is not diagonalizable by a Bogolubov transformation.

For sufficiently short crystal lengths |β(z)|² is approximately the same in both the hyperbolic regime one and the harmonic regime. Therefore, in many low-energy laser applications the practical operating point is harmonic. As demonstrated below, small deviations in the temperature quickly move the perfectly phase-matched process out of the hyperbolic regime.

A property of the harmonic regime is that there are ranges of positions along the crystal at which, due to the sinusoidal nature of the time evolution, the expected number of signal-idler pairs decreases along the propagation axis, going through zero and then increases again, unlike the behavior in the hyperbolic regime, in which the number keeps increasing exponentially along the propagation axis until the system goes out of the un-depleted regime. This can be used in order to produce only single pairs of entangled signal-idler photons robustly. Although robust solutions using composite designs can be found in the entire dynamical regime, this example focuses on the harmonic case that allows finding families of analytical solutions. The skilled person, provided with the details of the calculations described herein, would be able to obtain robust solutions also in the hyperbolic regime.

### SPDC in Different Directions

The process of SPDC can produce pairs of signal-idler photons in different directions. The direction of the incident pump propagation is referred to as the z direction. For example, the z direction can be perpendicular to the surface of the crystal. When the system is phase-matched in the same direction of the incident pump propagation and one asks about the output signal and idler waves of wavelengths λₛ and λᵢ and propagation directions of θₛ and θᵢ, the best performance of the process is phase-matched in the plane perpendicular to the direction of the incident pump propagation (the x-y plane in the present example). The energy conservation and momentum conservation in this plane are:

$$\frac{1}{{λ}_{s}} + \frac{1}{{λ}_{i}} = \frac{1}{{λ}_{p}} , \qquad ( 11 a )$$

$$\frac{sin {θ}_{s}}{{λ}_{s}} = \frac{sin {θ}_{i}}{{λ}_{i}} , \qquad ( 11 b )$$

and the mismatch in such process is

$$Δ k = Δ k ( {λ}_{s} , {θ}_{s} , T ) - Δ k ( {λ}_{s} , 0 , {T}_{perfect} ) , \qquad ( 12 )$$

$$where$$

$$Δ k ( {λ}_{s} , {θ}_{s} , T ) = \frac{2 π}{{λ}_{p}} {n}_{T} ( {λ}_{p} , 0 ) - ( \frac{2 π}{{λ}_{s}} {n}_{T} ( {λ}_{s} , {θ}_{s}^{′} ) cos {θ}_{s}^{′} + \frac{2 π}{{λ}_{i}} {n}_{T} ( {λ}_{i} , {θ}_{i}^{′} ) cos {θ}_{i}^{′} ) , \qquad ( 13 )$$

and the subscript “perfect” stands for perfect phase-matching which, under our assumptions, designed in the \hat{z} direction. Such equations can be generalized to any pair of signal and idler propagation angles (and not just to the phase matched pair).

### Sensitivity of SPDC

Following is a description of the applicability of the composite solution of the present embodiments in the CW case, but one of ordinarily skilled in the art would appreciate that the following guidelines can be applied also the case of a pulsed laser. The description is for an exemplified case of a perfectly quasi-phase-matched KTP crystal, but can be applied to any nonlinear crystal.

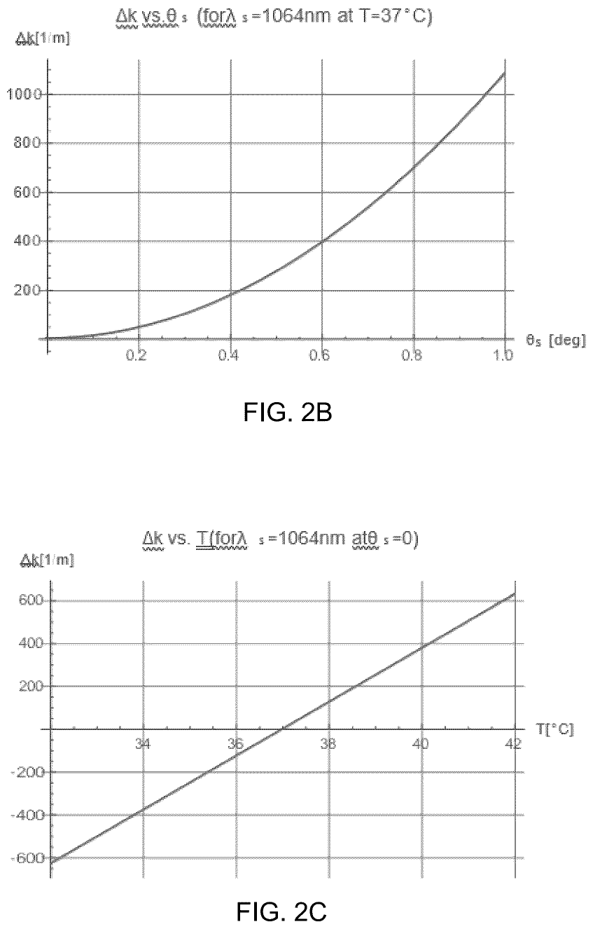

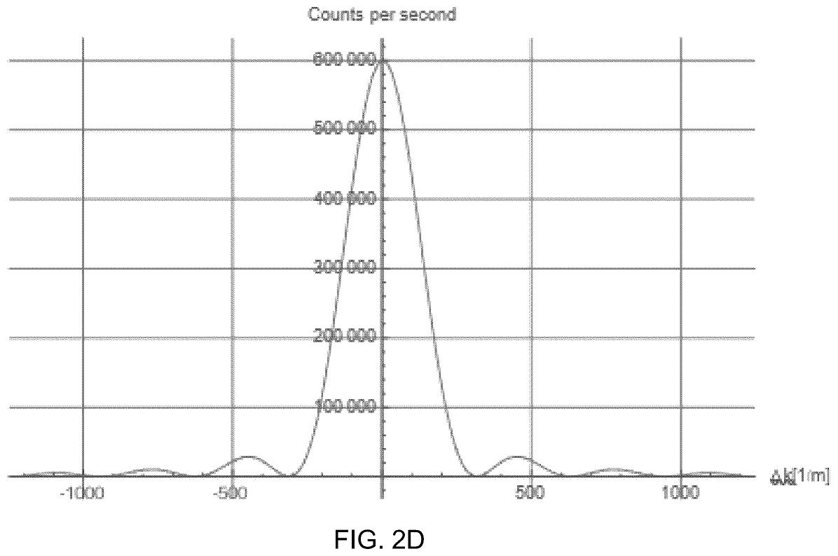

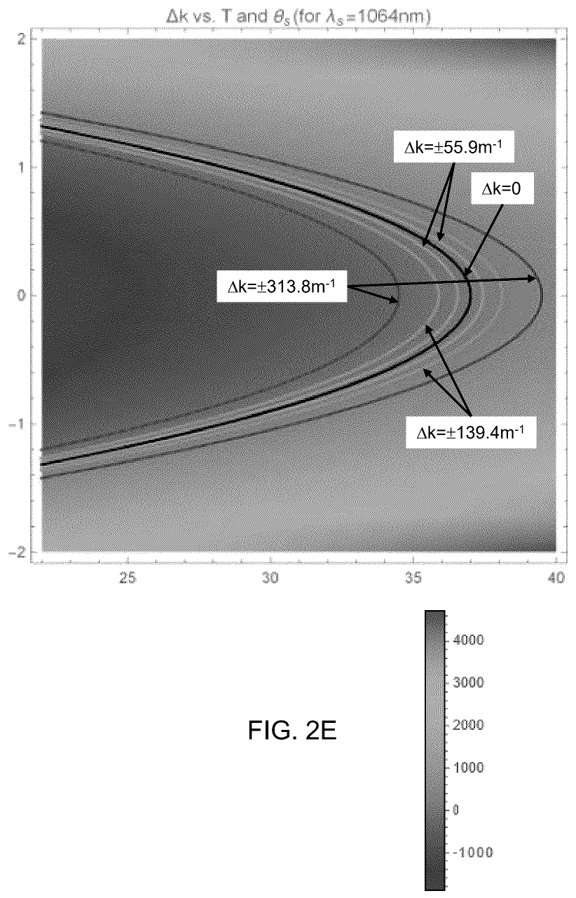

At a temperature range of from about 20° C. to about 100° C., the un-depletion condition is maintained under small variations of the incident pump's intensity and the output power for the idler is proportional to the incident pump intensity. The efficiency relates to the sensitivity of the phase mismatch to small variations of the signal and/or idler wavelength, the temperature, or the angle of measurement. For example, for a perfectly quasi-phase-matched KTP crystal of length 20 mm at T=37° C., a deviation of 0.445° C. in temperature, or 10.64 nm in the signal's wavelength, or only 0.2270 in the measurement angle, is sufficient to lower the rate of generated photons to 90% of the rate achieved by the error-free setup. This is due to the fact that in such processes κ is about 1 m⁻¹, while Δk changes with temperature by about 63 m⁻¹° C.⁻¹, so that the system enters the harmonic regime and the rate of generated entangled photons starts to decrease significantly. Further details regarding the sensitivity of Δk are shown in FIG. 2 in which (a), (b), and (c) show how Δk varies as each parameter changes while keeping the others at their optimal values, (d) shows how the rate of generated entangles pairs change with Δk, and (e) shows how Δk varies as T and θs change while keeping λs constant at 1064 nm.

From the standpoint of robustness it is therefore beneficial to design the crystal in the harmonic regime. The composite scheme reduces the conversion efficiency of the entangled photon generation output. But, this can be compensated, for example, by increasing the pump intensity. The robustness problem is solved by using the DMCS method of the present embodiments.

The Inventors unexpectedly found that when the sensitivity to small deviations in temperature is reduced while lowering the efficiency relative to the perfect non-robust process, the robustness of the system is also improved with respect to all other parameters.

### Composite Pulses and Segmentation

The NLO equivalent to the CP schemes are the CS schemes that are composed of crystal segments with different lengths, poling periods and initial poling phases. In the NLO realm, robust sum frequency generation (SFG) process obeying SU(2) dynamical symmetry can be achieved by using composite schemes [7].

This Example presents a CS scheme that uses, as the control parameters, the phase-mismatch and coupling coefficient for systems that display SU(1,1) dynamical symmetry. The CS schemes of the present embodiments allow robustness to different manufacturing and systematical errors compared to the commonly used phase-matched crystals, such as, but not limited to, PP-QPM crystals. The schemes of the present embodiments can also be robust to temperature variations and can eliminate the need for external temperature control accessories such as TECs and ovens.

### Detuning Modulated Composite Segments for Robust SPDC and OPA Processes

### Analytical Solution

The Inventors discovered an analytical solution to the problem of making the harmonic SPDC and OPA processes robust. According to some embodiments of the present invention the segments are composed and the errors of β² [EQ. 8] are canceled order-by-order. The error model used in this Example is that all the Δk's acquire the same error e due to an error in the wave vector of the crystal. Let Uₖ≡U(κₖ,Δkₖ,zₖ,ϵ) be a matrix generated from zₖ, κₖ, Δkₖ for the kth pulse of the kth segment, as in Eqs. (8) and (9), and let

$${U}^{( N )} ( ε ) ≡ {U}^{( N )} ( {\{ {κ}_{k} \}}_{k = 1}^{N} , {\{ {Δ k}_{k} \}}_{k = 1}^{N} , {\{ {z}_{k} \}}_{k = 1}^{N} , ε )$$

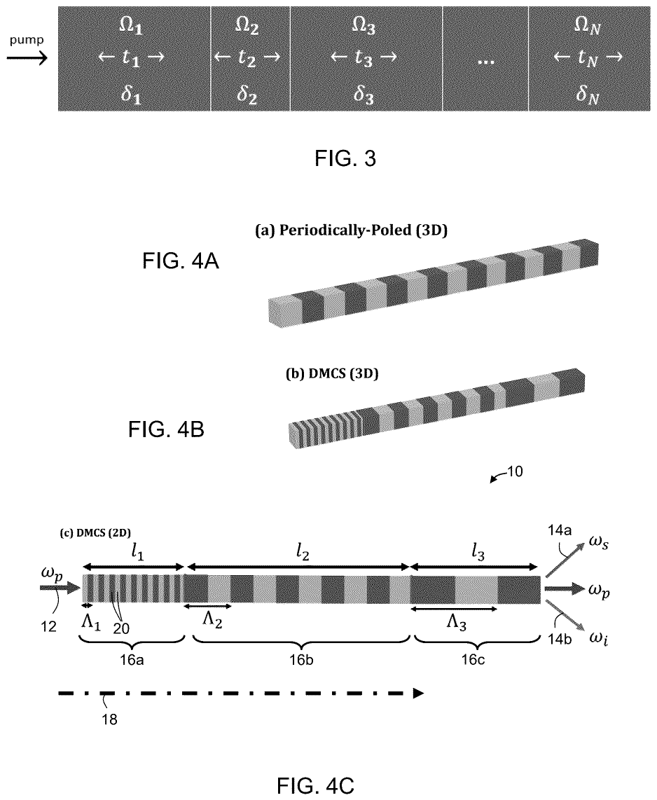

as in Eq. (14), below (see also FIG. 3),

$${U}^{( N )} ( ε ) ≡ {U}^{( N )} ( {\{ {κ}_{j} \}}_{j = 1}^{N} , {\{ {Δ k}_{j} \}}_{j = 1}^{N} , {\{ {z}_{j} \}}_{j = 1}^{N} , ε ) ≡ {U}_{N} … {U}_{2} {U}_{1} . \qquad ( 14 )$$

The matrices are optionally and preferably used to find an expression for β, which is used together with the constraints in order to calculate the values of Δk and κ.

To get a robust process, the goal is to find N and

$${\{ {κ}_{k} \}}_{k = 1}^{N} , {\{ {Δ k}_{k} \}}_{k = 1}^{N} , {\{ {z}_{k} \}}_{k = 1}^{N}$$

such that

$${\frac{\partial {\vert β ( ϵ ) \vert}^{2}}{\partial ε} \vert}_{ϵ = 0} = 0 ,$$

$${\frac{{\partial }^{2} {\vert β ( ϵ ) \vert}^{2}}{\partial {ε}^{2}} \vert}_{ϵ = 0} = 0 ,$$

$${\frac{{\partial }^{3} {\vert β ( ϵ ) \vert}^{3}}{\partial {ε}^{3}} \vert}_{ϵ = 0} = 0 ,$$

etc. Once solutions that fulfill these conditions are found, the value of |β(0)|² is determined

The found solution can be scaled to any requested length by multiplying the lengths by some positive r and dividing the Δk's by r, and the incident pump power by r². In this family of solutions, a robust solution around temperature Tₚ with deviation of up to Tₘ, is defined as a solution that satisfies

$$\frac{1}{2 {T}_{m}} {\int }_{{T}_{p} - {T}_{m}}^{{T}_{p} + {T}_{m}} {( \frac{μ ( T )}{μ ( {T}_{p} )} - 1 )}^{2} d T < α \qquad ( 15 )$$

keeping μ(Tₚ) lower by up to k_{μ} times than μ of a perfectly quasi-phase-matched crystal with the same total length of the segmented one, where α and k_{μ} are predetermined threshold parameters. Preferably, α is less than 0.1, e.g., α=0.01, and k_{μ} is at least 10, e.g., k_{μ}=50, such that the rate of generated entangled pairs of photons is much larger (at least 20 times) than the rate of background photons of the same wavelengths in our system, which is approximately 500 photons. In setting the values of α and k_{μ} for a specific application, one should guarantee a sufficient photon generation rate to the relevant physical system. In some embodiments of the present invention solutions are subjected to an acceptance criterion applied to the obtained values of Δk. Such an acceptance criterion can be based on manufacturing considerations, as further detailed hereinafter.

### Numerical Solution

Composite schemes for robust SPDC and OPA processes can be found also numerically, by defining a parameter space, and an objective function, and applying a selected search and optimization method to the parameters in the parameter space and the defined objective function.

The number of variables in the parameter space is linearly dependent on the number of segments in the scheme. The parameter space is optionally and preferably selected based on the composite scheme type. For example, in the Shaka-Pines scheme [3] the polling period is predetermined to yield an on-resonance conversion process (with no phase-mismatch) and so only the lengths of the different segments can be varied, while in the DMCS scheme both the segments' lengths and their poling periods can be varied. For each segment, the set of physical parameters that can be changed includes at least two of: the segment's length, the segment's poling period, and the initial poling phase of the segment. The numerical solution is optionally and preferably uses the incident pump intensity as an input fixed parameter.

The objective function can be adjusted to fit a predetermined set of criteria. For example, when it is desired to obtain a crystal that is robust to temperature variations, the objective function requires a sufficiently small value for the integral over T of a function of the ratio μ(T)/μ(Tₚ) (see, e.g., EQ. 15), and when it is desired to obtain a crystal that is robust to variations in Δk and κ the objective function requires a sufficiently small value for the integral over [symbol] , \tilde{κ} of a function of the ratio μ(T, [symbol] ,\tilde{κ})/μ(T,Δk,κ), e.g.,

$${\int }_{Δ k - Δ {k}_{ν a r}}^{Δ k + Δ {k}_{ν a r}} {\int }_{κ - {κ}_{ν a r}}^{κ + {κ}_{ν a r}} {( \frac{μ ( T , \tilde{Δ k} , \tilde{κ}}{μ ( T , Δ k , Ω )} - 1 )}^{2} d \tilde{Δ k} d \tilde{κ} , \qquad ( 16 )$$

where Δkᵥₐᵣ and κᵥₐᵣ are predetermined parameters that describe the maximal excepted variations in Δk and κ due to manufacturing errors and variations of the system's environment (e.g., temperature variations). The integrals of the objective function are optionally and preferably evaluated numerically, e.g., replaced by a sum.

The optimization can be any according to any search and optimization method known in the art. Preferably, optimization method is non-convex. Representative examples of search and optimization methods suitable for the present embodiments including, without limitation, nonlinear programming, e.g., simulated annealing or genetic optimization.

In simulated annealing, the optimization begins at a random point inside the allowed set of parameters and a random search is initiated at a point inside a hypersphere centered at this point, where the hypersphere forms a subset of the parameters that is within a certain radius from the initial point. Each time a point that is better than the current best point is found, the center of the allowed hypersphere is moved to this point. The radius of the hypersphere is reduced dynamically for each set of random search queries. The algorithm ends after a predetermined number of total search queries or after it fails to show a certain amount of improvement for a predetermined number of search queries.

In genetic optimization, the optimization begins with a set of random points that are in the allowed set of parameters. In each generation of the optimization the value of the objective function value is calculated for of each point and is defined the score of the point. Then, the optimization selects some of the point to combine with other successful points, and/or get some random additive errors to its values to create the next generation, while enforcing the constraints of the allowed set of parameters. In addition some of the highest score points get passed to the next generation. The genetic optimization stops when the improvement between generations is lower than a predetermined threshold for a certain number of generations or when the number of number of generations exceeds a predetermined threshold.

### Polings

The periodically poled scheme for a crystal with a length of L and a phase-mismatch of Δk that matches a process of λₚ→λₛ+λᵢ at temperature Tₚ is optionally and preferably designed with the following poling, under the constraint that L is much larger (e.g., at least 5 or at least 10 times larger) than 2π/Δk:

$${χ}^{( 2 )} ( z ) = \vert {χ}^{( 2 )} \vert sign ( cos ( {Δ k}_{pol} \cdot z ) ) = {χ}^{( 2 )} \vert sign ( cos ( \frac{2 π}{Λ} \cdot z ) ) , \qquad ( 17 )$$

where Λ is used also in Eqs. (2) and (13). Illustrations of the periodic poling method are given in FIG. 4.

From the standpoint of manufacturing simplicity, it is oftentimes desired to manufacture a crystal in which polarization domains have lengths that are multiples of δl, and that are larger than a minimal domain length Λₘᵢₙ, where δl and Λₘᵢₙ are characteristic to the fabrication of a specific crystal material. A typical value for δl is, without limitation, about 25 nm, and a typical value for Λₘᵢₙ is, without limitation, about 3000 nm. In order to achieve a particular Δk for the crystal, the following method for the sign of the nonlinear susceptibility is used:

$${χ}^{( 2 )} ( z ∈ ( ( j - 1 ) δ l , j δ l ) ) = \vert {χ}^{( 2 )} \vert sign ( cos ( {Δ k}_{pol} \cdot j δ l ) ) , \qquad ( 18 )$$

where the index j varies 1 to L/δl. EQ. 18 can be used as acceptance criterion that can be applied to each value of Δk obtained in the solution. Specifically, the solution for Δk is preferably accepted when the obtained lengths are not shorter than Λₘᵢₙ, and rejected otherwise. For a segmented design, where Δkₚₒₗ is a function of z, EQ. 18 becomes:

$${χ}^{( 2 )} ( z ∈ ( ( j - 1 ) δ l , j δ l ) ) = \vert {χ}^{( 2 )} \vert sign ( cos ( {\int }_{0}^{j δ l} {Δ k}_{pol} \cdot j δ l ) ) , \qquad ( 18.1 )$$

### Results

Following is a description of eight segmented KTP crystals designed for robust SPDC of 60 mW incident 532 nm pump with beam radius of 150 μm at Tₚ=37° C. The signal and idler are each of 1064 nm wavelengths and at θ=0. The crystal are denoted by roman numbers I through VIII.

Each of crystals I through VI included 6 antisymmetric segments:

$${Δ k}_{6} = - {Δ k}_{1} , \qquad ( 19 )$$

$${Δ k}_{5} = - {Δ k}_{2} ,$$

$${Δ k}_{4} = - {Δ k}_{3} ,$$

where the length Z of each segment with a half phase mismatch of Δk is:

$$Z = \frac{π}{2 \sqrt{{( \frac{Δ k}{2} )}^{2} - {κ}^{2}}} . \qquad ( 20 )$$

It is to be understood that this configuration serves as an example and is provided for the purposes of illustrative discussion of embodiments of the invention. Other relations between z, κ and Δk are also contemplated. Further, while the number of segments in crystals I through VI is 6, the crystal of the present embodiments can include any number of segments. In some embodiments of the present invention the number of segments is even and in some embodiments of the present invention the number of segments is even.

Each of crystals VII and VIII included 10 antisymmetric segments, forming the vector of Δk values:

$$( {Δ k}_{1} , - {Δ k}_{1} , {Δ k}_{2} , - {Δ k}_{2} , {Δ k}_{3} , - {Δ k}_{3} , {Δ k}_{2} , - {Δ k}_{2} , {Δ k}_{1} , - {Δ k}_{1} ) . \qquad ( 21 )$$

The relation between lengths, Z, of these segments and the respective values of Δk and κ are as described in Eq. 20, above.

Table 1, below provides further details of the parameters of the eight designs for crystal 10, specifying, for each crystal, the phase mismatches of Δk_{1,2,3} [see Eqs. 19 and 20 for crystals I-VI, and Eqs. 20, 21 for crystals VII and VIII], the total length of the crystal, the ratio between the efficiency μ of generating entangles pairs and the efficiency μₚₚₘ of generating entangles pairs in a perfectly phase-matched crystal with the same total length, and the robustness width, which is the width along the temperature axis in which the rate of generated pairs of entangled photons decreases to 90% of its maximum.

TABLE 1
Crystals providing robust SPDC at T = 37° C.

| | | | | robustness |
|---|---|---|---|---|
| | Δk₁, Δk₂, Δk₃ | Ltotal | | width |
| Crystal | [1/m] | [mm] | μ/μₚₚₘ | [° C.] |
| I | 3935.29, −3935.29, −449.769 | 17.163 | 15.978% | 11.5155 |
| II | 8432.76, −8432.76, −887.712 | 8.568 | 17.237% | 22.1545 |
| III | 1840, 445, −9700 | 9.091 | 15.800% | 21.092 |
| IV | 4000, 54800, −886 | 8.777 | 16.708% | 16.057 |
| V | 3985, 1000, −16250 | 8.247 | 15.459% | 23.482 |
| VI | 3563.45, 35634.5, −779.505 | 10 | 16.984% | 14.838 |
| VII | 34482.8, 12069, −862.069 | 8.694 | 18.556% | 20.740 |
| VIII | 10285.7, 67142.9, −857.143 | 8.739 | 18.607% | 20.671 |

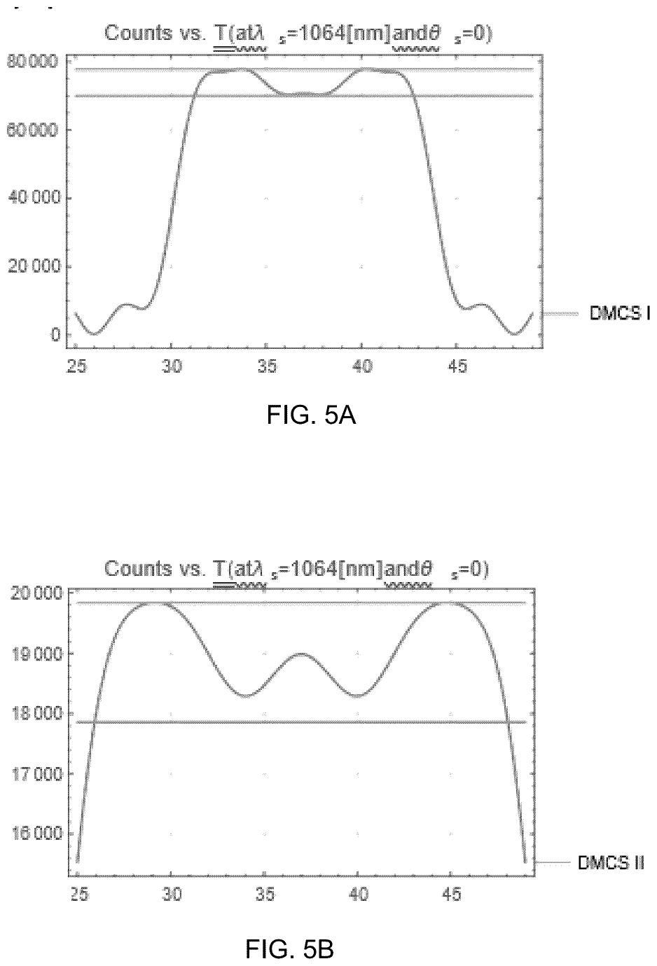

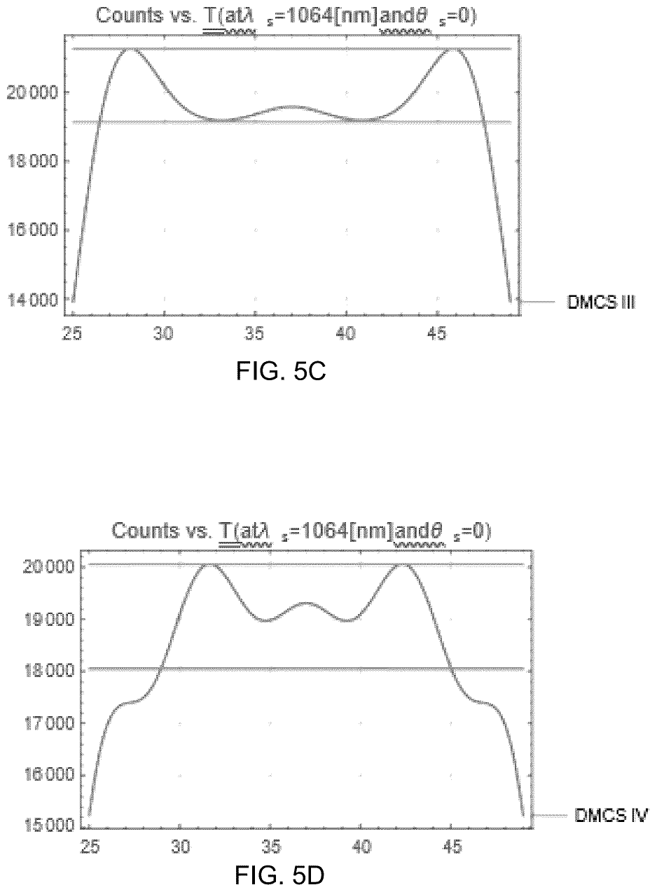

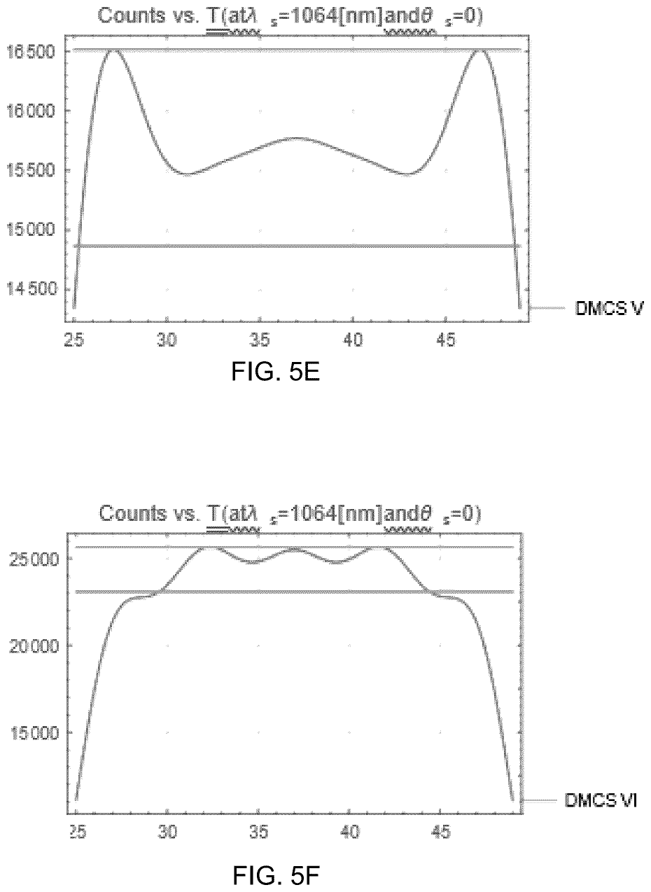

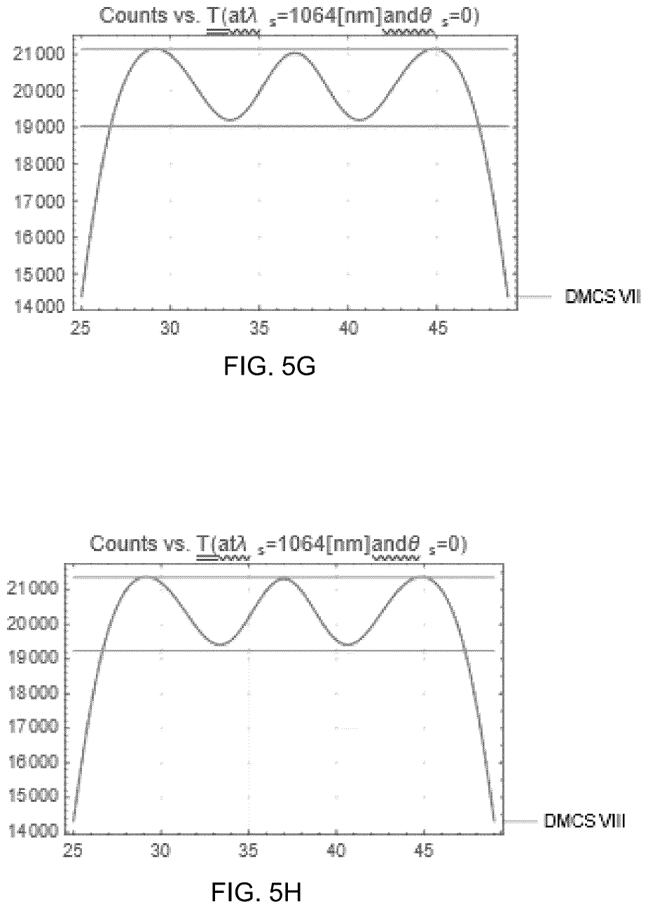

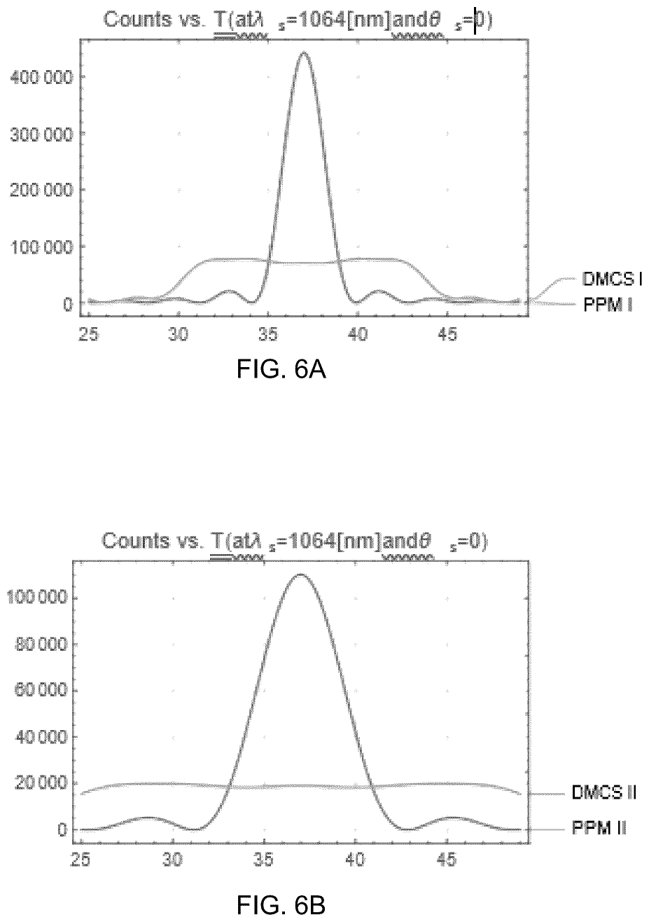

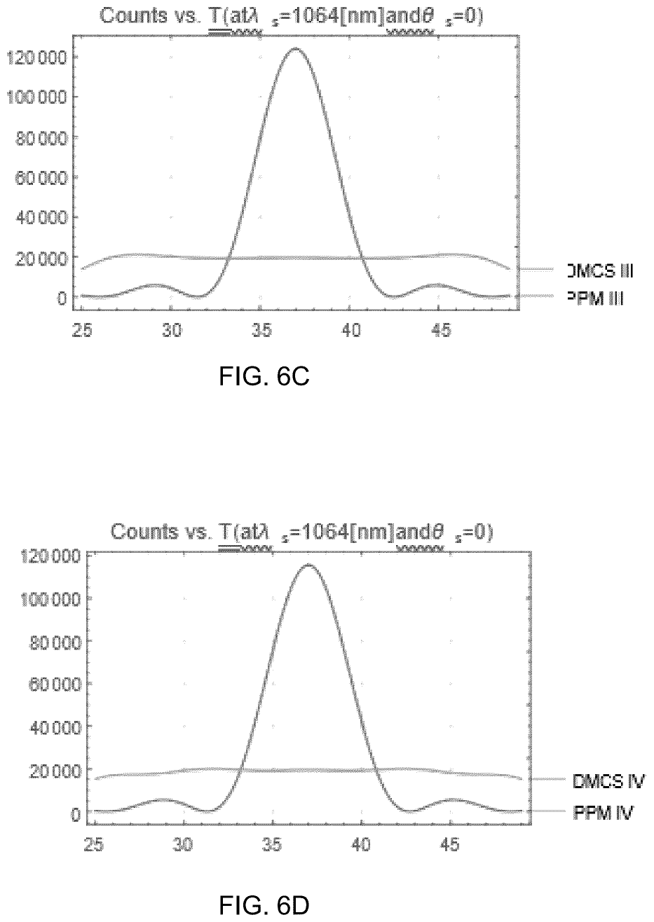

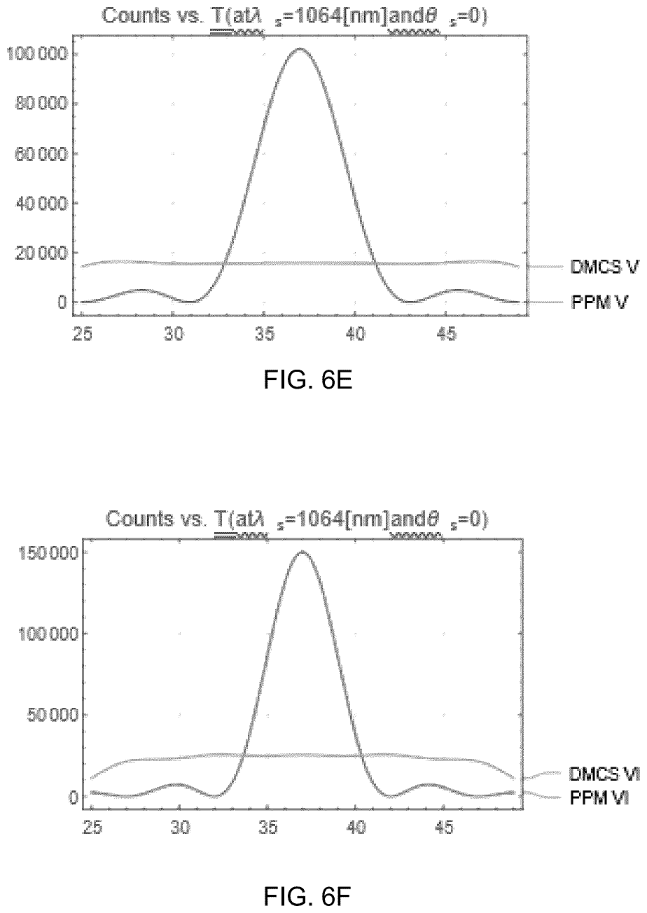

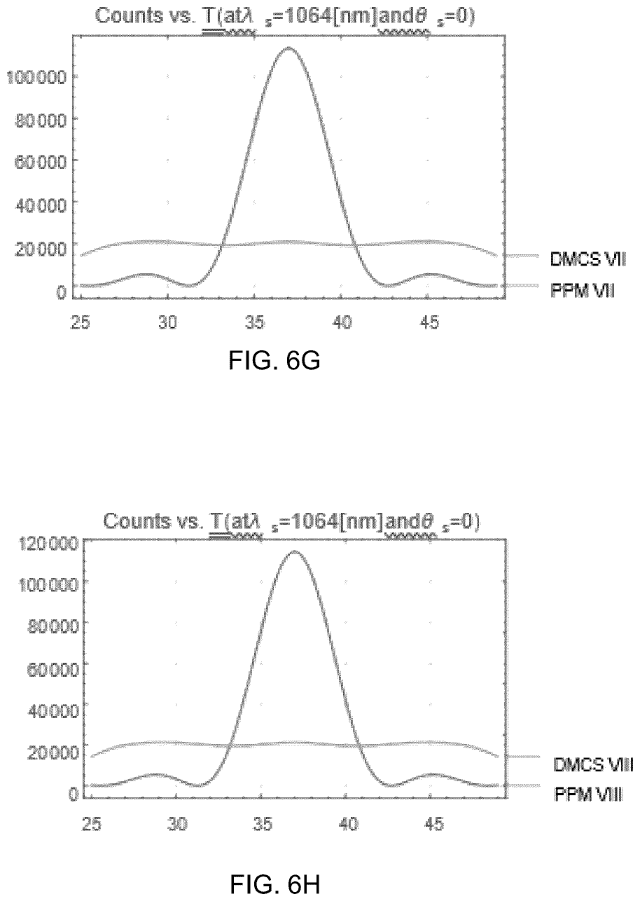

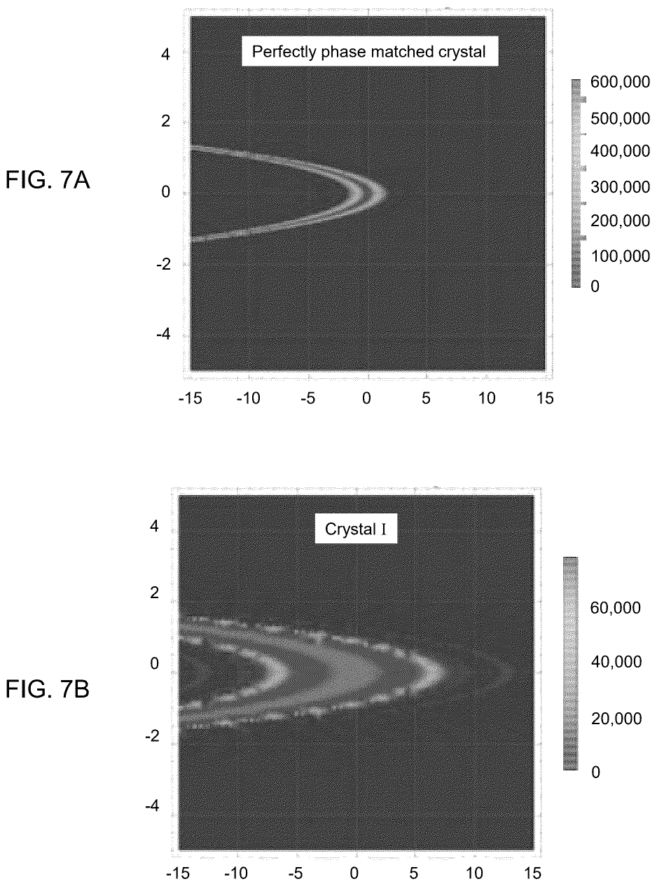

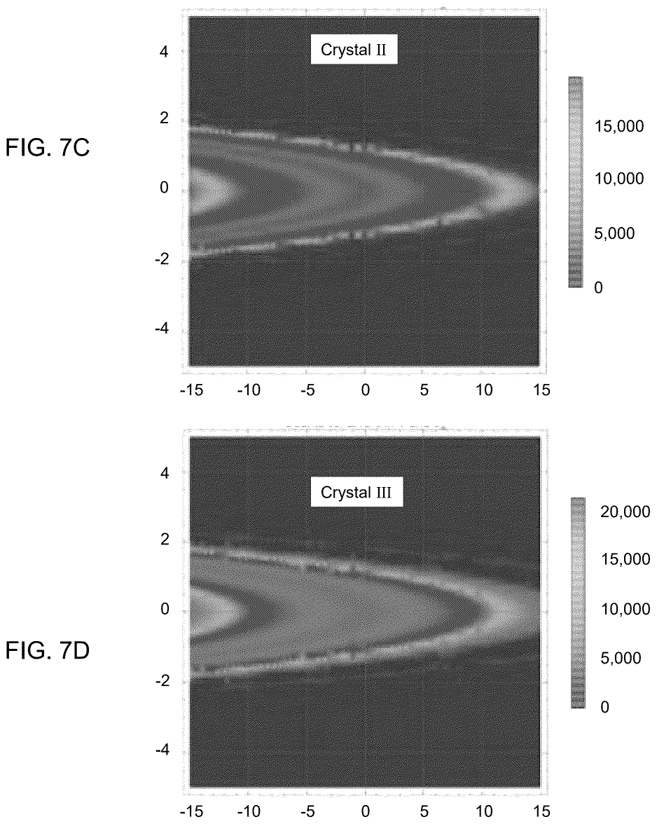

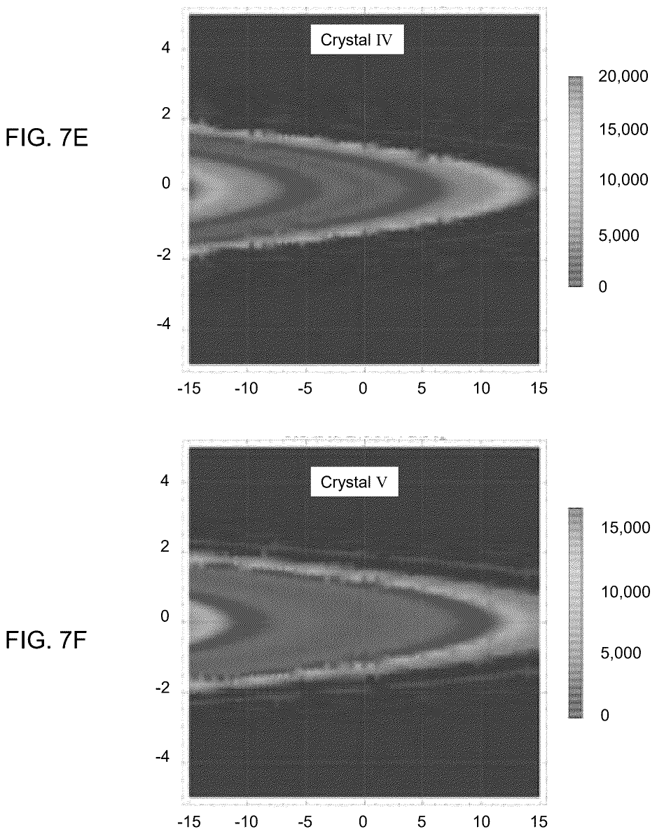

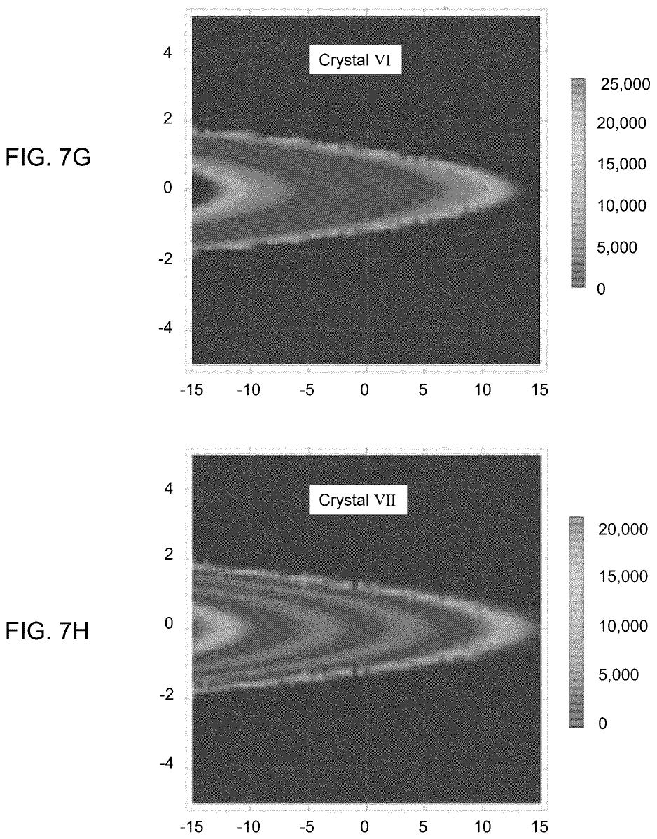

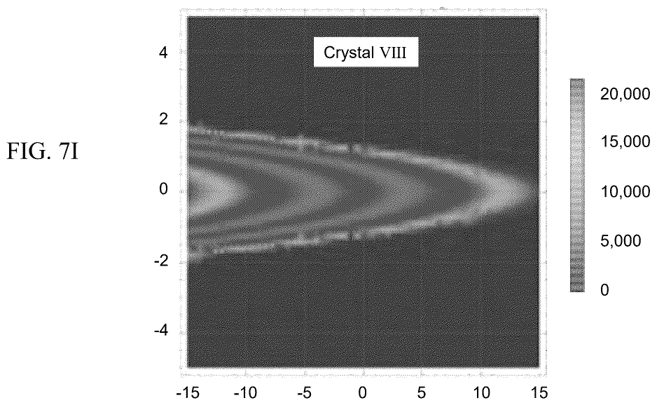

FIGS. 5A-H show the number of generated entangled pairs per second as a function of the temperature for each DMCS design, and FIGS. 6A-H show the number of generated entangled pairs for a perfectly phase matched crystal with the same total length. FIGS. 7A-I show the counts as a function of the temperature deviation from 37° C. and θₛ for a perfectly phase matched crystal of length 20 mm (FIG. 7A) and for the DMCS crystals of the present embodiments (FIGS. 7B-I).

As long the intensity of the pump is nondepleted, the robustness described above is maintained. Variations, δPₚᵤₘₚ, in the pump's incident power, Pₚᵤₘₚ, induces a corresponding variation, δP_{signal/idler}, in the intensity power, P_{signal/idler}, of the signal and idler:

$${δ P}_{pump} / {P}_{pump} = {δ P}_{signal / idler} / {P}_{signal / idler} . \qquad ( 22 )$$

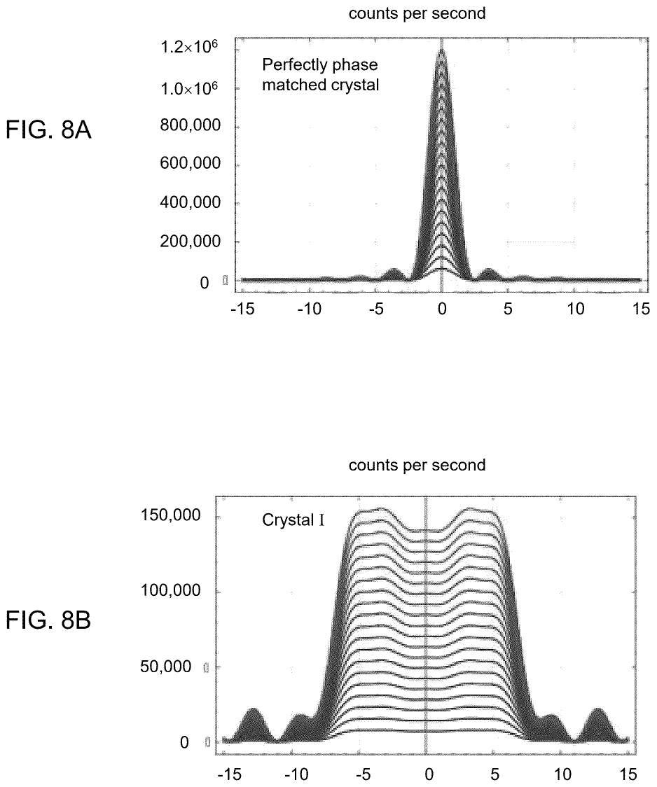

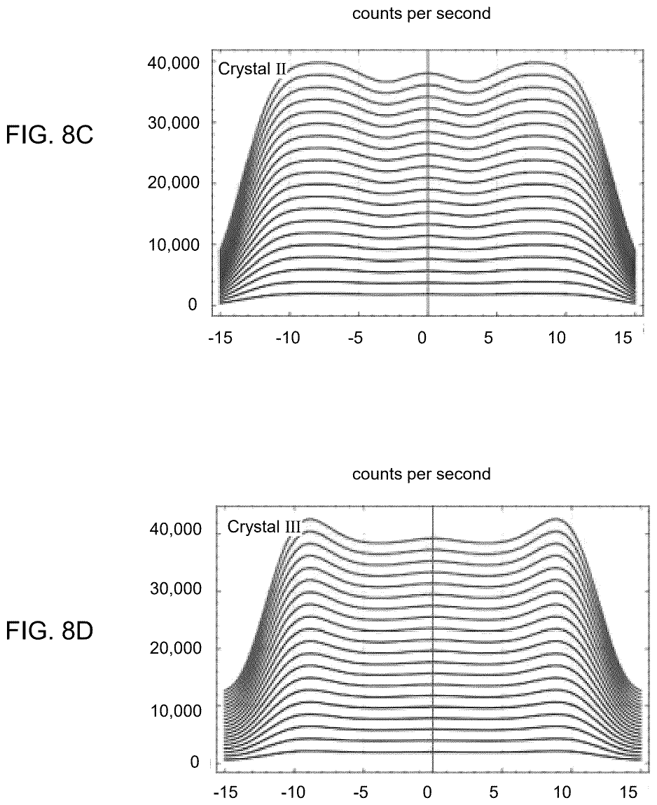

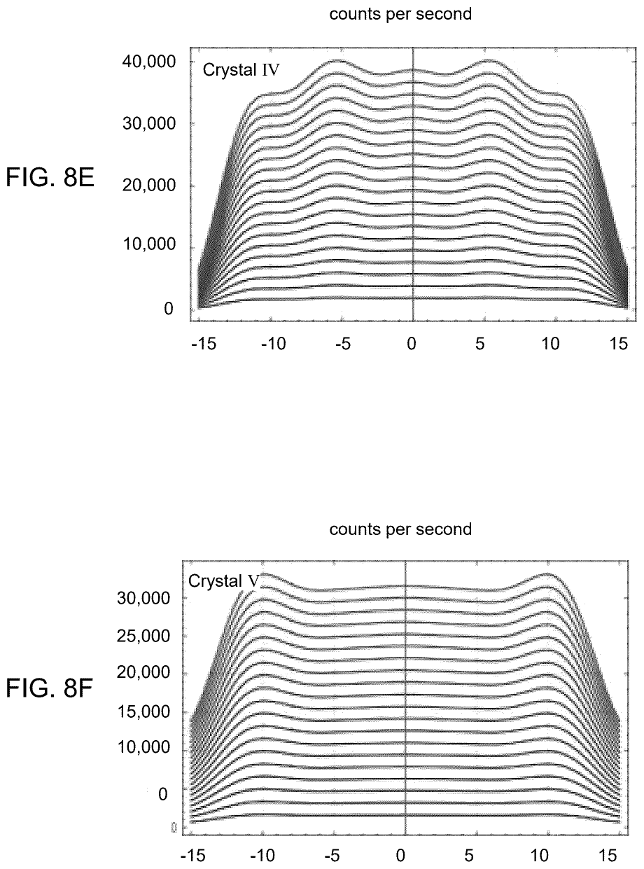

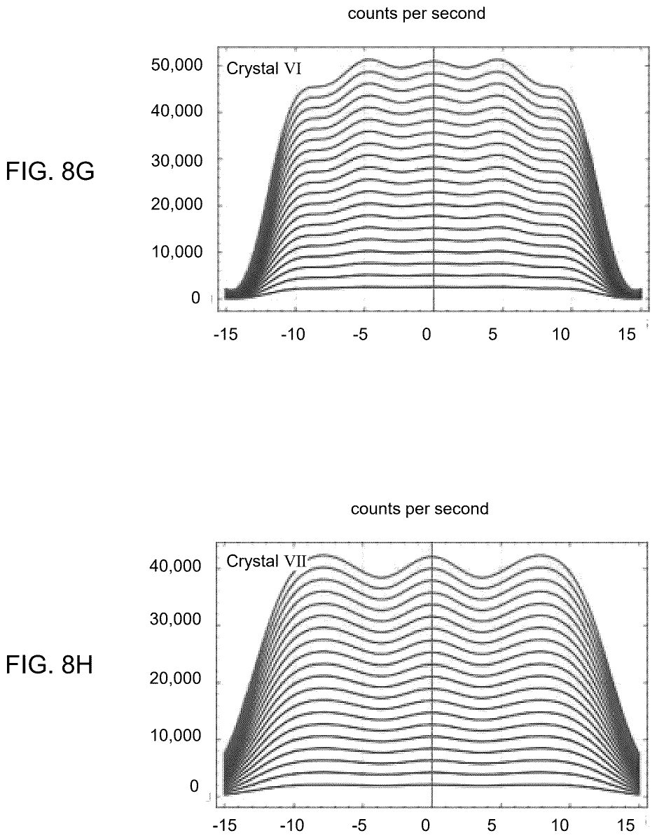

FIGS. 8A-I show the number of generated entangled pairs per second as a function of the temperature deviation from 37° C. (at θₛ=0) for 20 different incident powers of the pump of a perfectly phase matched crystal of length 20 mm (FIG. 8A), and the eight DMCS crystals of the present embodiments (FIGS. 7B-I). The curves correspond to different values of the ratio δPₚᵤₘₚ/Pₚᵤₘₚ, where the bottommost curve corresponds to a ratio of −0.9, and each curve correspond to an increment of the ratio by +0.1 relative to the curve immediately below it, such that the topmost curve corresponds to a ratio of +1. As shown, the robustness of the process is maintained under deviations in the incident pump's intensity.

The results shown in FIGS. 5A-7I were performed by multiplying the un-depleted evolution matrices the same way as in Eqs. (8) and (9) using the parameters of the crystals. This type of simulations yields sufficiently accurate quantum results, for an un-depleted pump along the crystal.

The following presents simulations for OPA calculated via a numerical fourth-order Runge-Kutta algorithm that solves the full evolution of the three equations of OPA [Eq. (6)] for the case where the crystals are those described above in Eq. (18) with δl=25 nm. In the un-depleted pump approximation, the semi-classical OPA that is simulated with vacuum-like signal and idler fields is assumed to resemble the SPDC process. The numerical simulations presented in this Example are for the case of non-dispersive phenomena with quasi-CW light beams, without any high-order parasitic nonlinear effects. The skilled person, provided with the details in this Example, will be able to include also dispersive effects and the Kerr effect.

The Inventors simulated a system where monochromatic quasi-CW pump (Aₚ), signal (Aₛ), and idler (Aᵢ) lasers propagate through a QPM crystal (similarly to FIG. 4C) each with its own propagation angle. The following examples describe the case where the incident pump propagates perpendicularly to the input face of the crystal (δₚ=0°) and the signal and idler angles uphold the constraint of Eq. (11b).

In the simulation, the temperature (T) and the signal angle (θₛ) were varied, and as a result idler angle (θᵢ) was also varied. The angle variations directly change the phase-mismatch along the z axis. The effect of temperature variations stems from two different effects: (i) the thermo-optic effect changes the refractive index of the material, and (ii) thermal expansion changes the segments' lengths and their poling periods. The simulation were for KTP crystals designed to work at 37° C. at different temperatures, up to 10° C. relative to the working point. The thermo-optic effect is calculated according to [34] and the thermal expansion coefficient according to [35].

The average number of output signal/idler photons per second were calculated for temperatures and angles, and a plot that displays the effect of the parameters' variation on the output count rate was created. The count rate, Nₒᵤₜ, is given by

$${N}_{out} = \frac{[ {I}_{s} ( z = {L}_{c} ) - {I}_{s} ( z = 0 ) ] \cdot {ω}_{p}}{{I}_{p} ( z = 0 ) \cdot {ω}_{s}} \cdot \frac{{I}_{p} ( z = 0 ) {λ}_{s}}{hc} \cdot A \qquad ( 23 )$$

where Iₛ(z) and Iₚ(z) are the signal and idler intensities at position z along the crystal, ω_{s,p} are their frequencies, h is the Plank constant, c is the speed of light in vacuum, L_{c} is the total crystal length and A is the crystal's face area. The crystals that are listed in Table above were simulated. In this example, the crystal is designed for an input wavelength of λₚ=532 nm, which results in wavelengths of λₛ=λᵢ=1064 nm. Since the parameters of the crystals are scalable, the simulation results are applicable for any other wavelength.

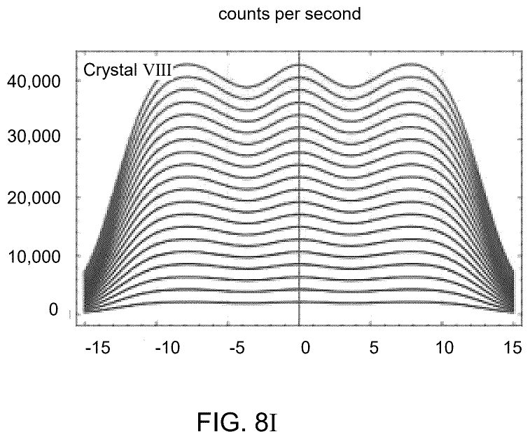

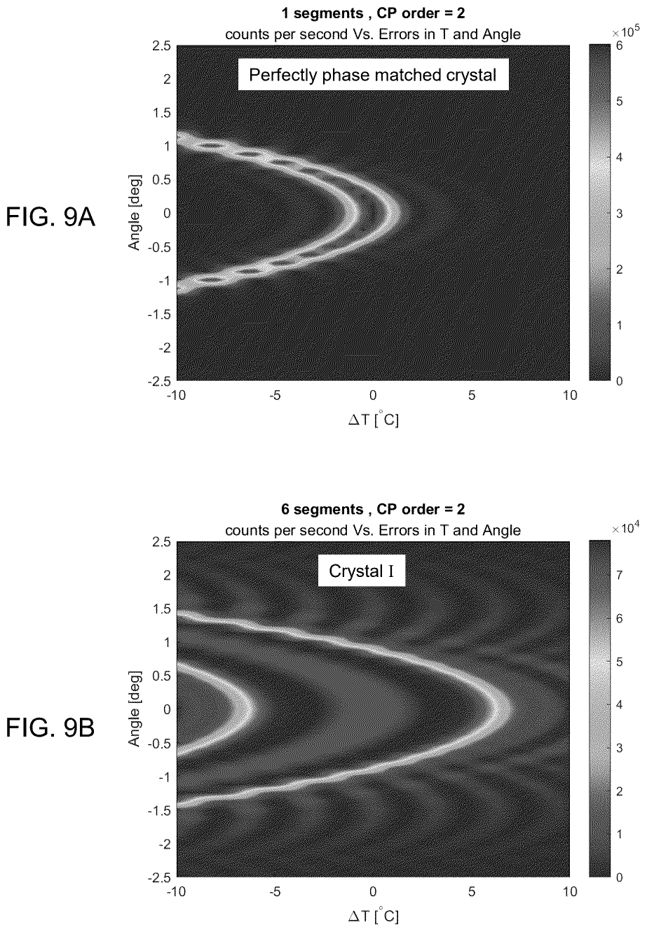

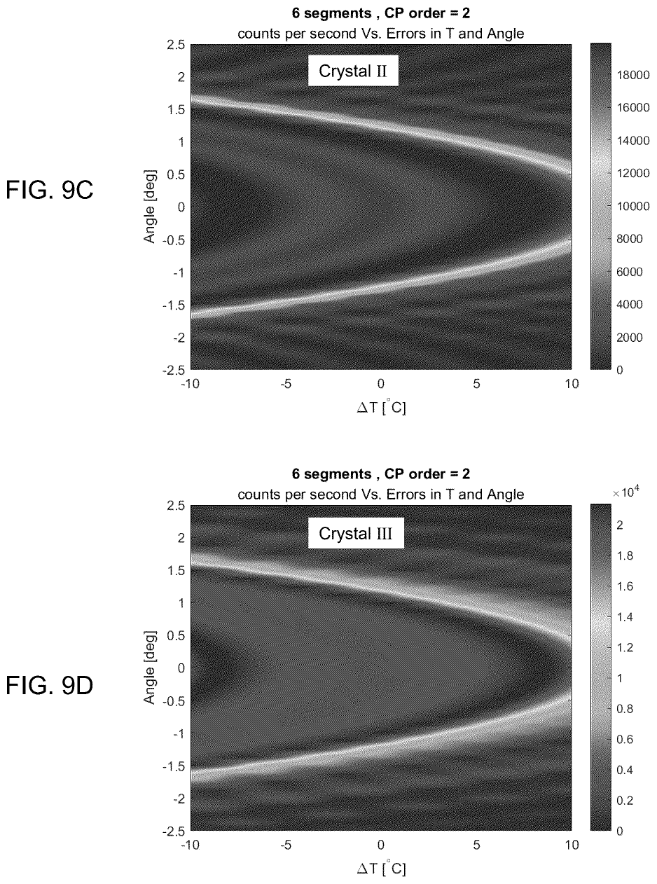

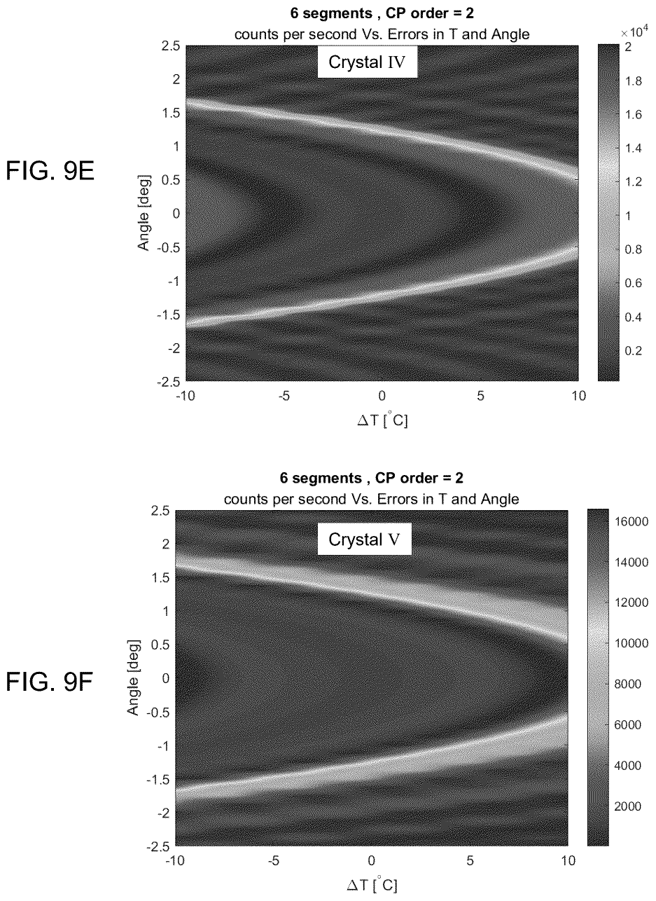

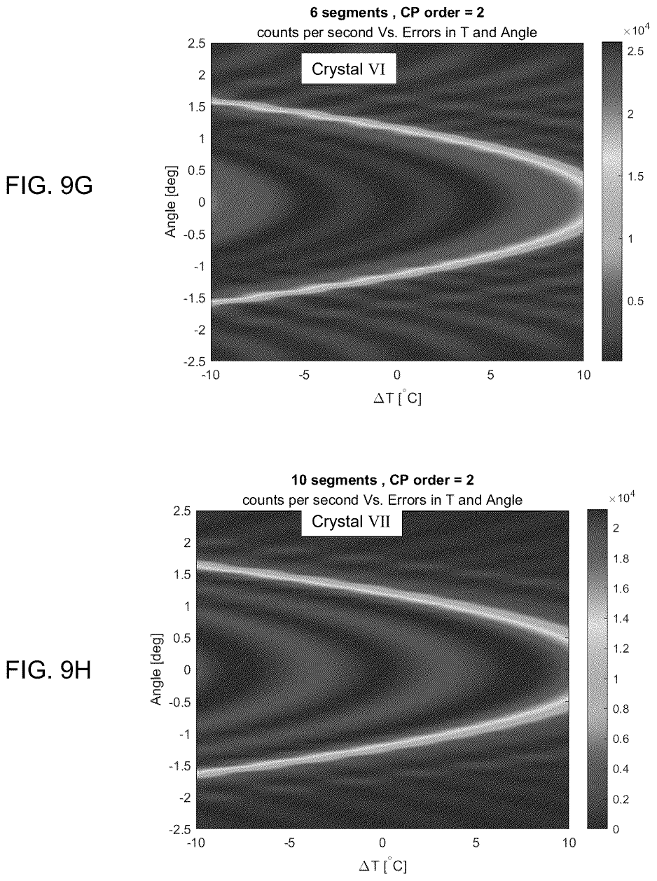

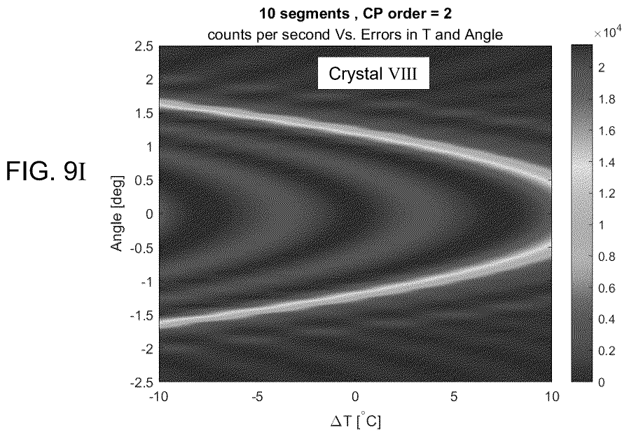

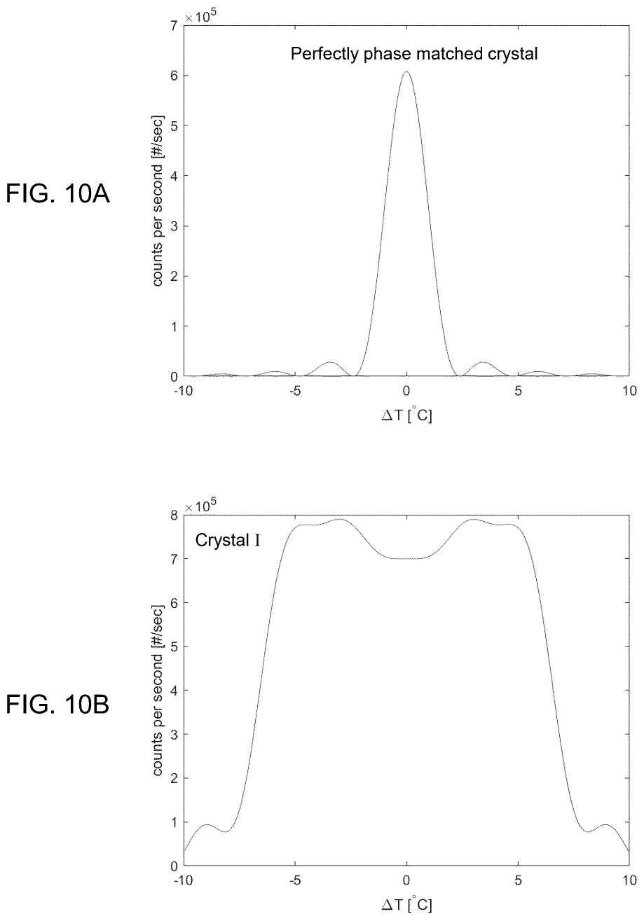

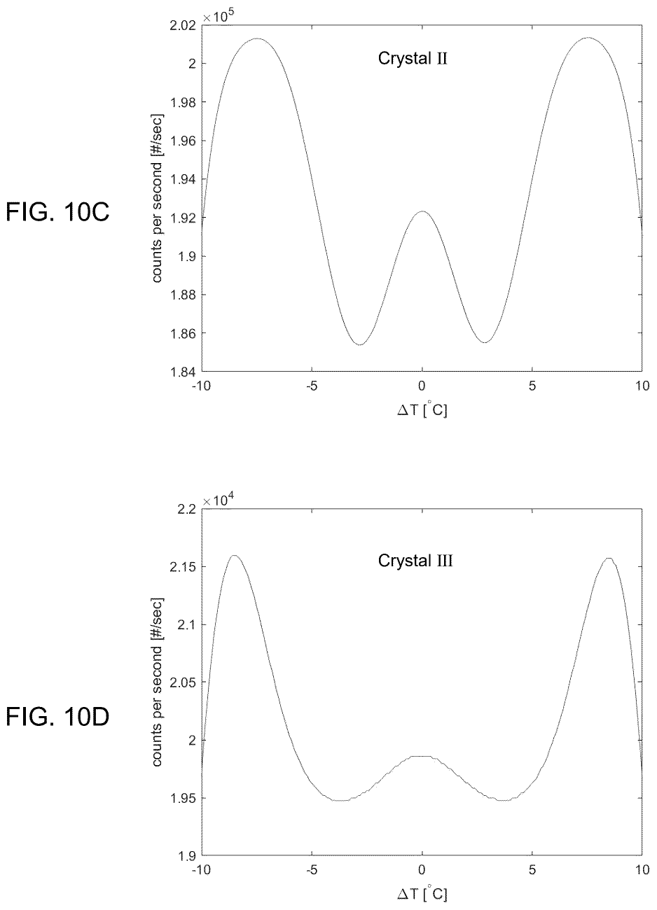

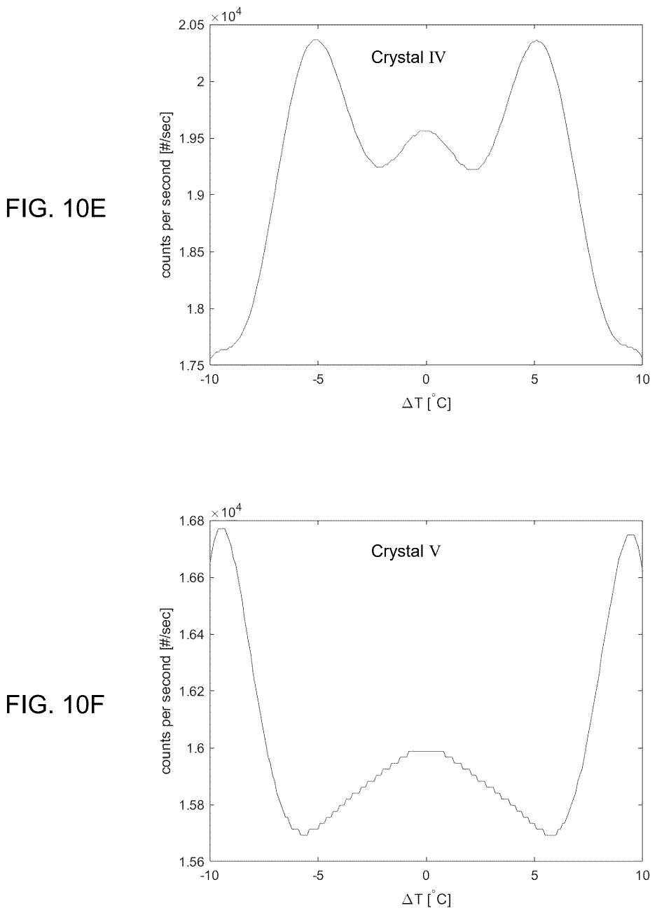

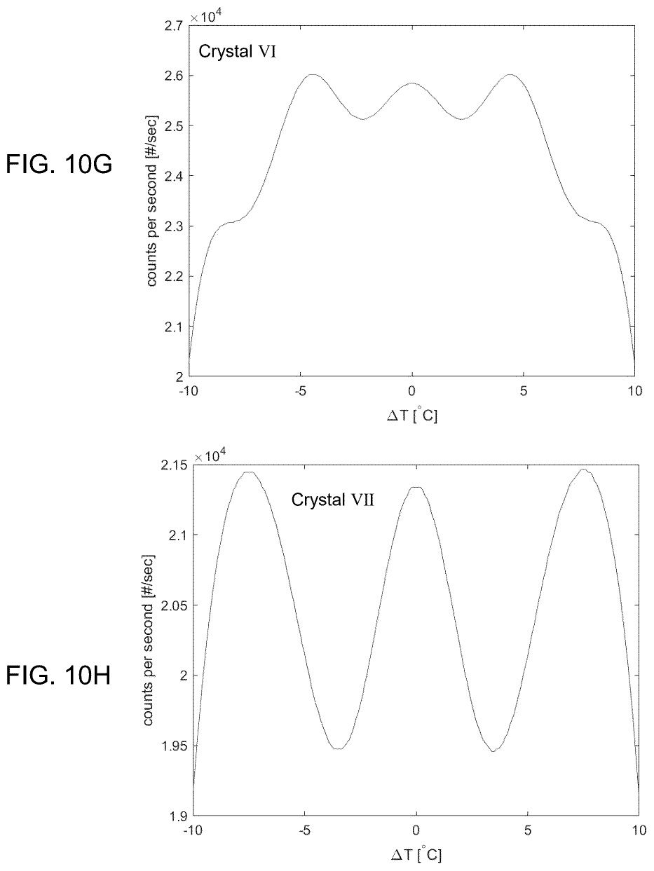

FIGS. 9A-I, we present maps of the simulated average count rate for a perfectly phase matched crystal (FIG. 9A) and for the eight DMCS crystals of the present embodiments (FIGS. 9B-I) at the designated wavelength of 1064 nm for setups with different temperatures and signal angles. FIGS. 10A-I, shows the simulated average count rate of the perfectly phase matched crystal (FIG. 10A) and the eight DMCS crystals of the present embodiments (FIGS. 10B-I), for a colinear setup at the designated wavelength of 1064 nm for different temperatures.

### Prophetic Experiments

KTP crystals are obtained with the QPM designs of the present embodiments and the results of the simulations are verified. This is done by altering the designs to match an SPDC process at an angle of 3°-5°, which allows to separate the signal and idler spatially. Then, the count rate in one of the output channels is measured for different temperatures and angles. In addition to verifying the simulation results, additional measurements are taken to evaluate and the use of the scheme of the present embodiments for a variety of quantum applications. A coincidence measurement between the signal and idler in varying temperatures and angles evaluates the average number of usable photon pairs under different conditions. An HBT experiment [36, 37] evaluates the rate of high order pair generation, and a HOM experiment [38] demonstrates the indistinguishability between the photons that compose the generated pairs when creating a degenerate process.

In some embodiments of the present invention the value of χ⁽²⁾ as a function of z is a piecewise constant function. In some embodiments of the present invention χ⁽²⁾ has only one of the two values ±|χ⁽²⁾|. In other embodiments (for example, when the segments are of different materials or different orientations), χ⁽²⁾ can have more than two values.

Let

$$ϕ ( z ) = {\int }_{0}^{Z} Δ {k}_{crys} ( {z}^{′} ) {dz}^{′}$$

be the phase of χ⁽²⁾ (the argument of the cosine in EQ. 18,1), and let {pₙ} be a finite sequence of points in the z−φ(z) plane satisfying pₙ=(zₙ,φ(zₙ)=πn). At any point in the set {pₙ}, χ⁽²⁾ changes its sign since cos(nπ)=0. According to some embodiments of the present invention the minimal window at which the numerical derivative of φ(zₙ) is substantially piecewise continuous contains less than 100 points of the sequence.

As used herein a derivative is said to be “substantially piecewise continuous” when the ratio between the standard deviation of the derivative and its average is less than 0.01 or 0.001.

According to some embodiments of the present invention the phase-mismatch function Δk(z) is substantially piecewise constant.

As used herein a function is said to be “substantially piecewise constant” when the ratio between the standard deviation of the function and its average is less than 0.01 or 0.001.

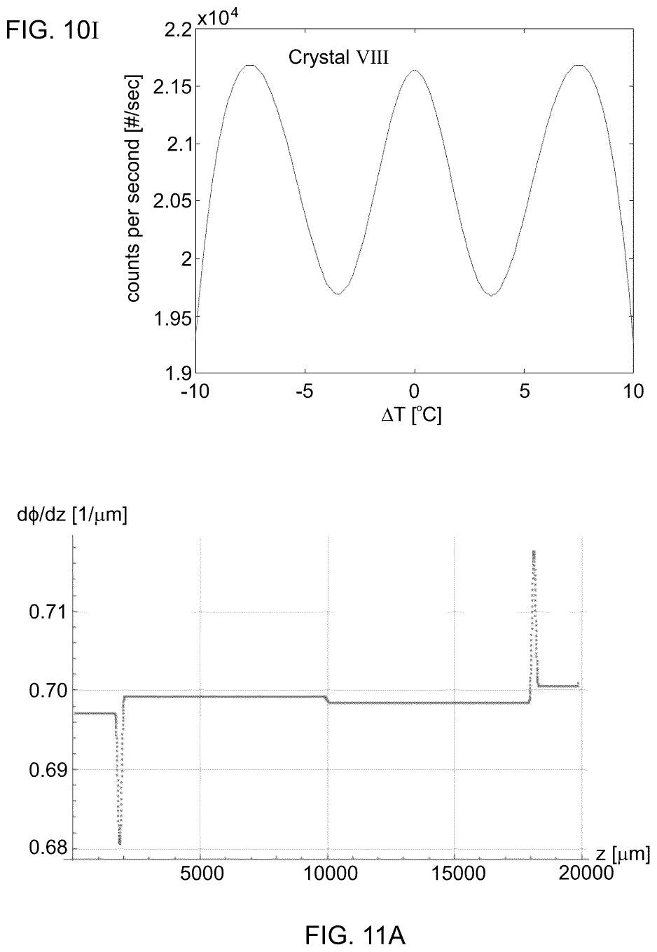

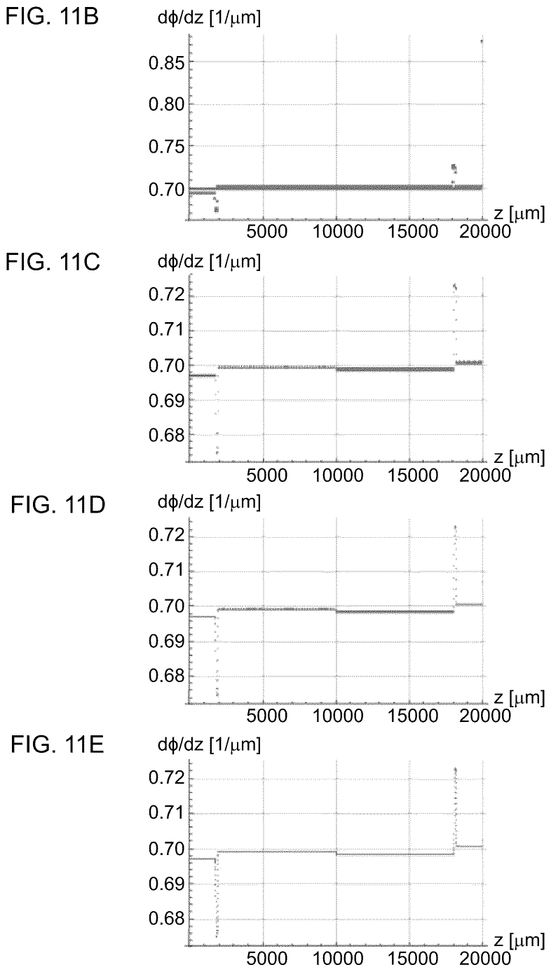

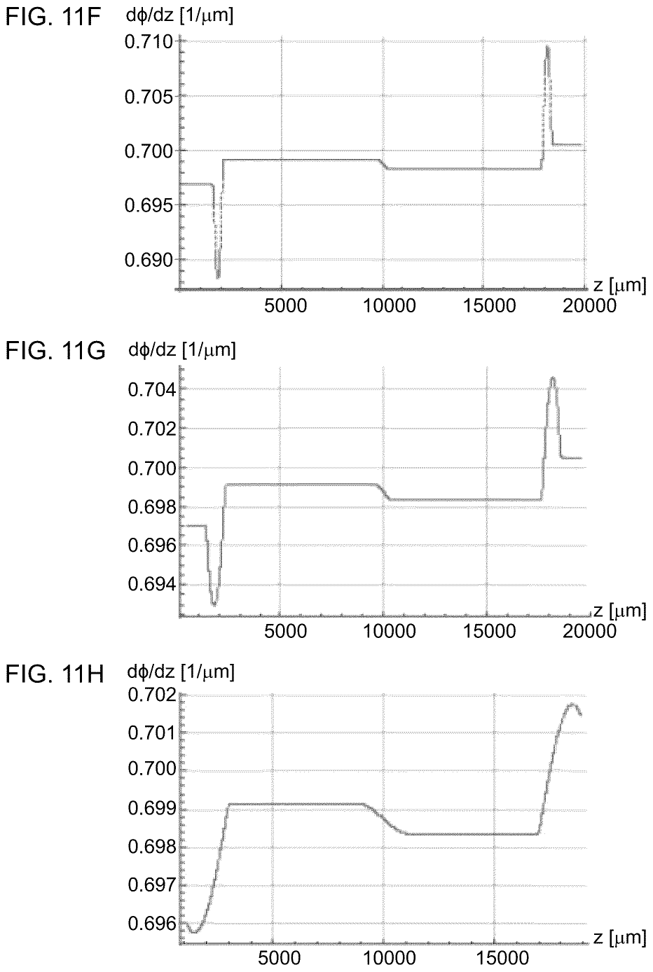

FIG. 11 shows an example of the derivative for the aforementioned DMCS crystal IV for 2 cm when δl=25 nm and Λₘᵢₙ=3000 nm. In FIG. 11A, a window of 50 points was used for the numeric derivative. Note that these are 6 segments: the second and the fifth are short relatively. As shown the values of the Δk are proper for sufficiently long segments. FIGS. 11B-H are similar to FIG. 11A, except that in FIGS. 11B-H the numeric derivative was calculated over windows of 1, 5, 10, 20, 100, 200 and 500.

### EXPERIMENTS

Experiments and computer simulations were directed to investigate the crystal optionally and preferably through a “robustness width”, which is the width along the temperature axis in which the rate of generated pairs of entangled photons decreases to 90% of its maximum. A schematic of the experimental system is illustrated in FIG. 16. In the experiment, a CW pump laser 30 with a wavelength of 532.25 nm, power of 80 mW, and beam waist of 150 μm was shined through a patterned KTP crystal. The crystal was manufactured by Raicol Crystals Ltd. and contained a periodically poled (PP) crystal 34 and alongside it the crystal 10 of the present embodiments. Both crystals were designed to create a type-0 colinear degenerate SPDC from 532 nm to 1064 nm. The translation stage was used to align one of crystals 10 and 34 with the optical path of the pump 12. The temperature of the crystal was controlled with a TEC and a thermometer to a precision of 0.1° C. After passing the crystal (10 or 34), the pump was filtered out by a 1064 line filter, and the beam containing the signal and idler (shown collectively as 14) was coupled into a single-mode fiber and through it to a single-quantum superconducting nanowire single-photon detector (SNSPD) 32.

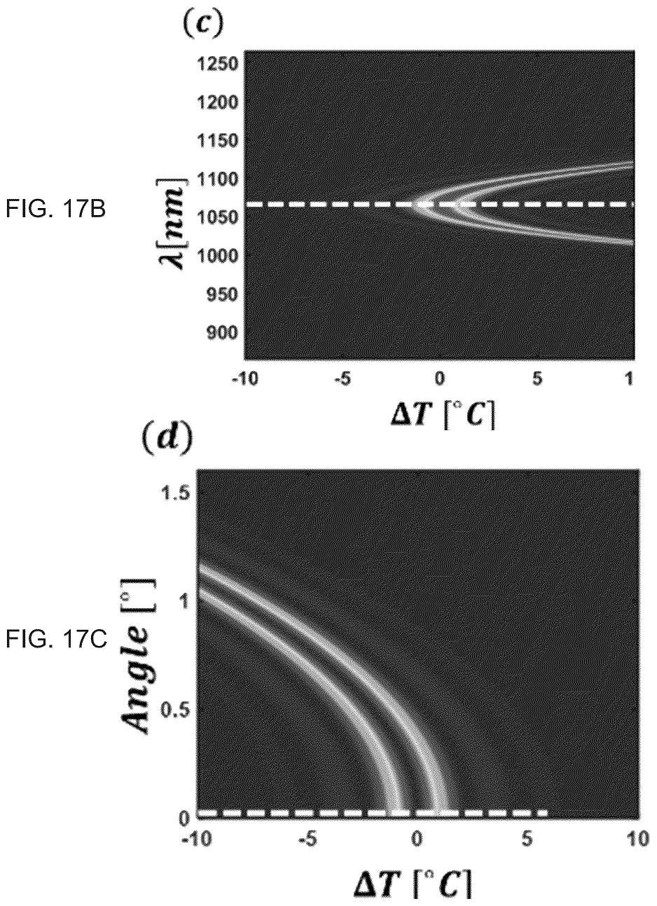

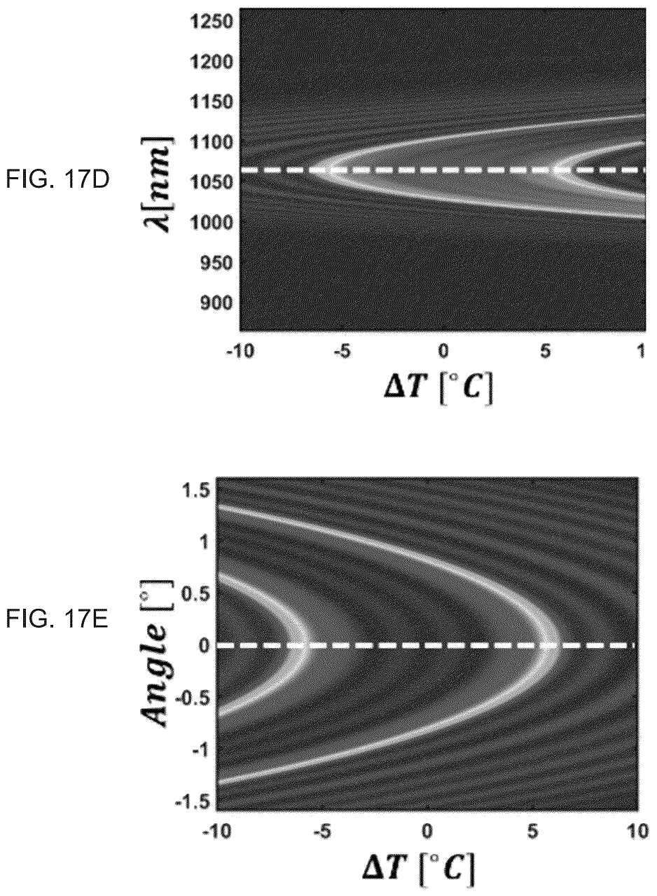

Experimental and simulation results are shown in FIGS. 17A-E, where the experimental results are shown as crosses, and the simulation results are shown as curves. In FIG. 17A, the normalized count rate of a periodically poled (PP) crystal and the composite-poling crystal 10 of the present embodiments relative to their maximal rates versus the temperature deviation from a work temperature of 40.5° C. for crystal 10 and 66° C. for crystal 34 is shown. FIGS. 17B-E are two-dimensional color coded maps showing normalized count-rate as a function of the temperature deviation from the desired work temperature of 37° C. and the signal wavelength (FIGS. 17B and 17D) and as a function of the temperature deviation from the desired work temperature and of the signal angle (FIGS. 17C and 17E) for the PP crystal (FIGS. 17B-C) and for the composite poling crystal 10 of the present embodiments (FIGS. 17D-E).

According to the numerical simulation results, the composite-poling crystal 10 of the present embodiments has a robustness width greater by eight and a half times than the width of the periodically poled crystal 34 and a fourfold increase in robustness to pump-angle variations. Experimentally, the composite design crystal 10 of the present embodiments was found to have a width of 5° C. at 90% of its peak count rate, more than a sevenfold increase compared to the 0.7° C. width of the periodically poled crystal 34. The peak count rate of the conversion process was 138.5 kcps (103 counts per second) for the composite-poling crystal 10 compared to a 306 kcps at the peak of the periodically poled crystal 34—only a twofold decrease in the count rate. In addition, taking into account manufacturing errors, measurement noises, and system imperfections (gaussian beams instead of plane waves) the results adequately fit the simulations.

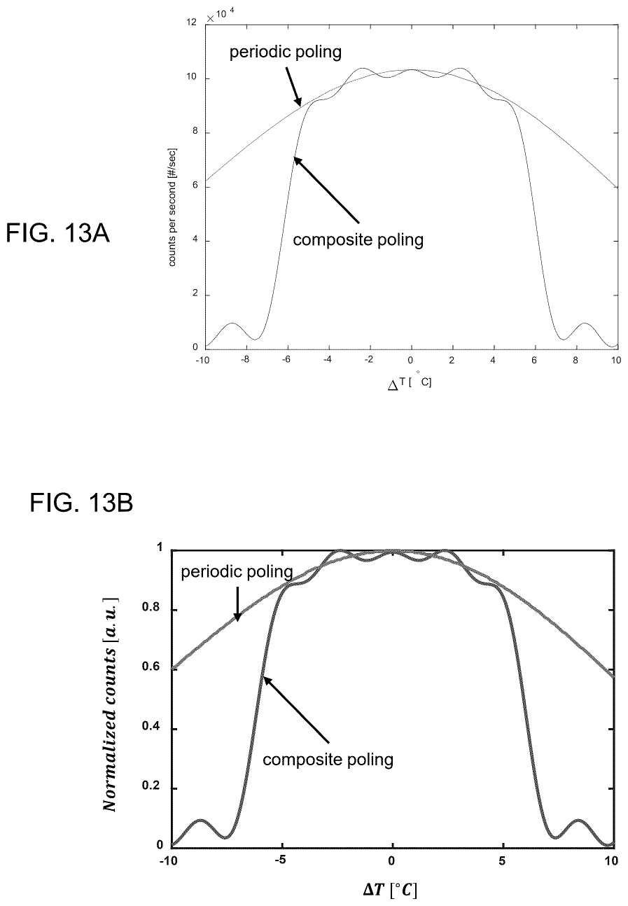

FIGS. 13A and 13B show a matching of the robustness width of the PP crystal 34 to that of the composite-poling crystal 10 of the present embodiments. The parameter triplet of crystal 10 are listed in Table 1, crystal VI. The total length was 20 mm for crystal 10 and 2 mm for crystal 34. In order to get the same output power, the PP crystal 34 was pumped with 17 times higher pump power than crystal 10 of the present embodiments. In order to have a similar robustness width, the PP crystal 34 should be ten times shorter than crystal 34. On the other hand, the PP crystal 34 requires a much higher pump power than crystal 10 optionally and preferably in order to obtain a similar count rate.

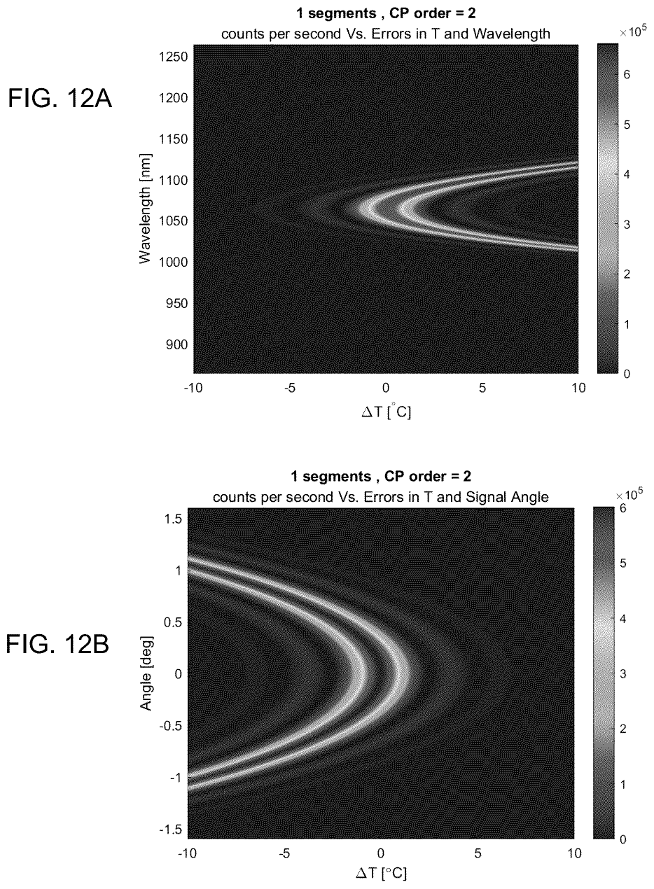

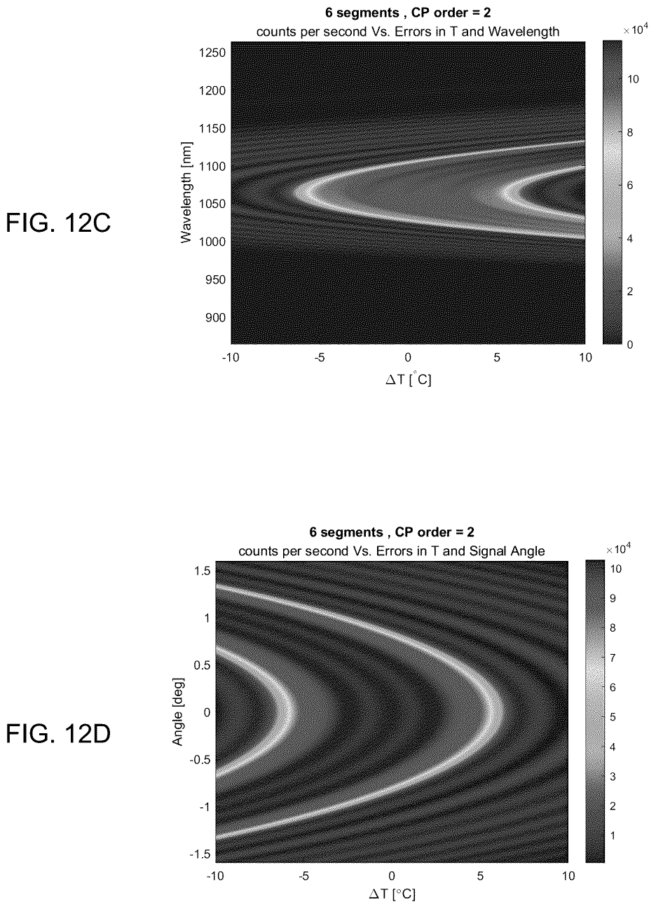

FIGS. 12A-D are two-dimensional color coded maps showing numbers of generated entangled pairs per second as a function of deviations from a temperature of 37° C. and a zero angle of incidence, as calculated for bulk QPM periodically poled Type-0 SPDC (FIGS. 12A-B) and for bulk QPM Composite-Poling colinear Type-0 SPDC of the present embodiments, for wavelength conversion of 532 nm to 1064 nm.

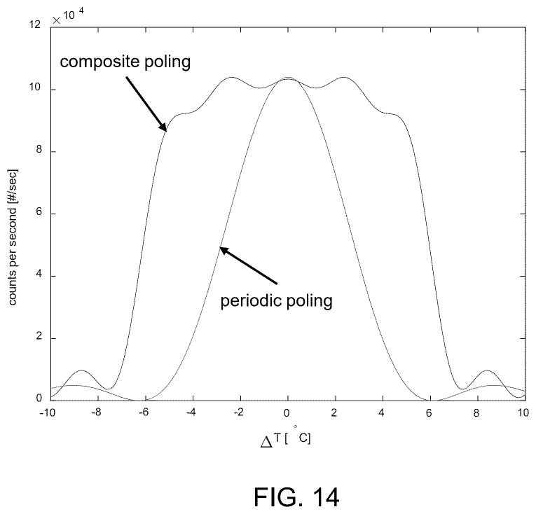

FIG. 14 shows a comparison of composite-poling crystal according to some embodiments of the present invention and a periodic poling crystal with a length selected such that output power is same at peak.

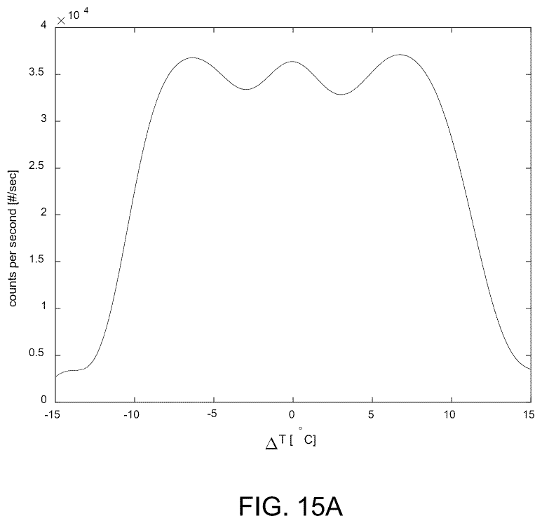

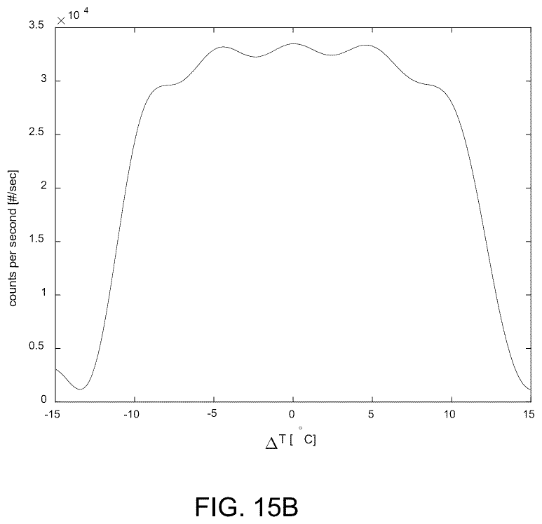

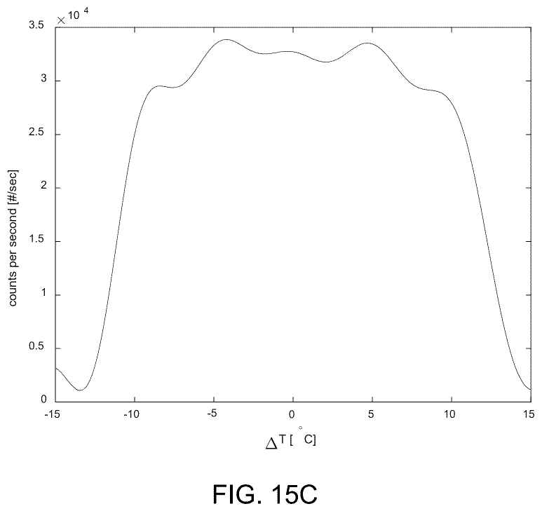

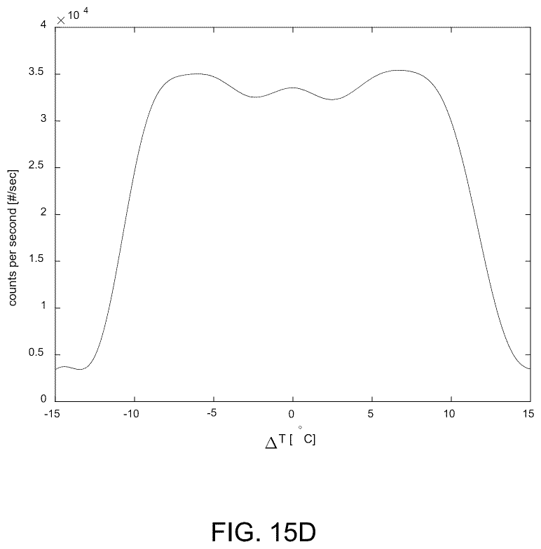

FIGS. 15A-D show numbers of generated entangled pairs per second as a function of deviations from a temperature of 37° C. for colinear type 2 composite-poling SPDC of the present embodiments and for wavelength conversion of 405 nm to 810 nm.

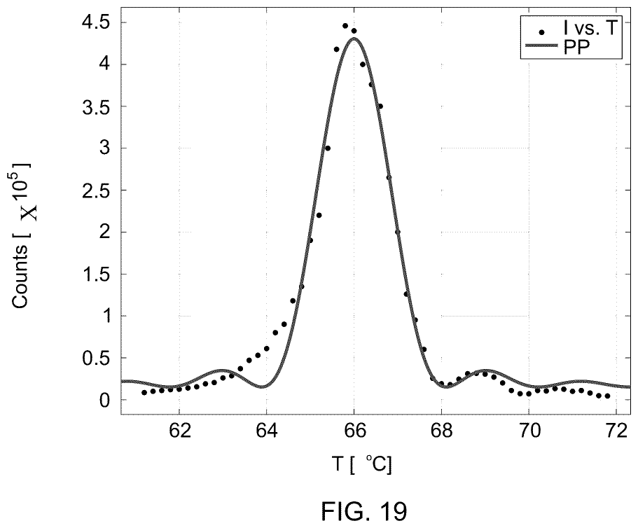

FIG. 19 shows a fit to measurements performed to of the periodic poling crystal 34.

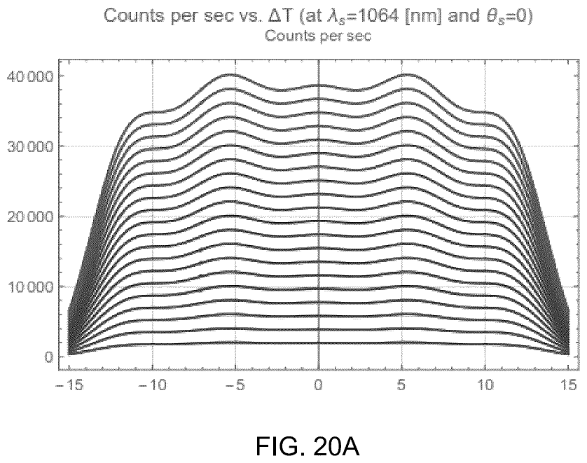

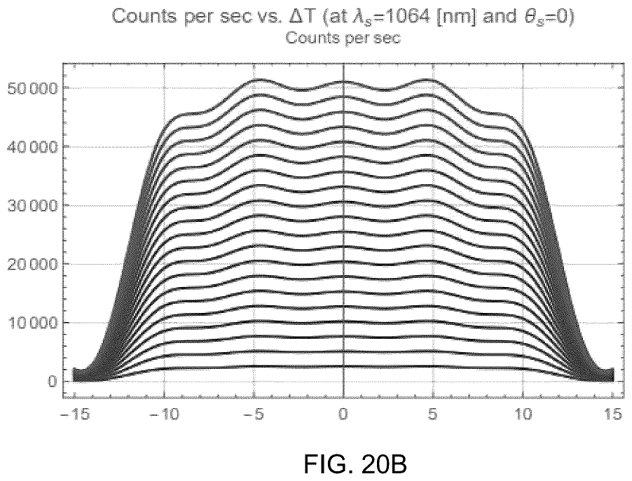

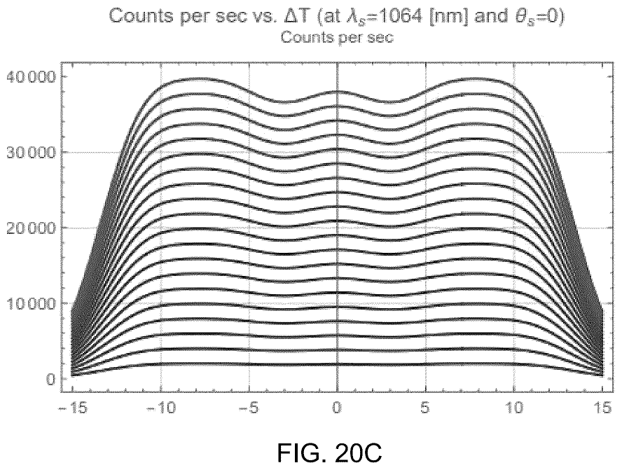

FIGS. 20A-D show count rate as a function of the temperature for different pump power for and DMCS crystals, listed in Table 1, above, and enumerated II, IV, VI, and VIII, respectively, demonstration of linearity of the count rate with respect to the pump power.

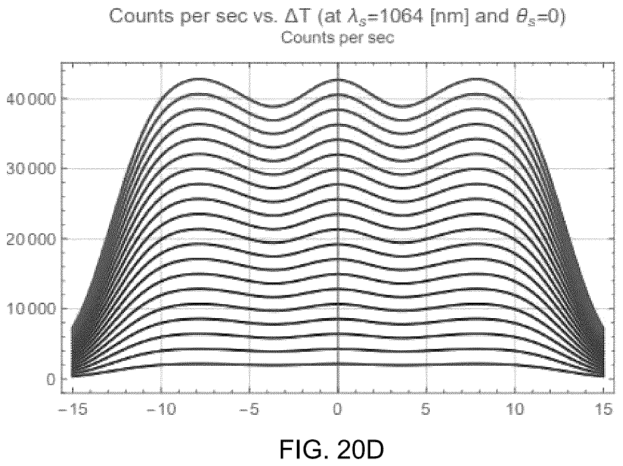

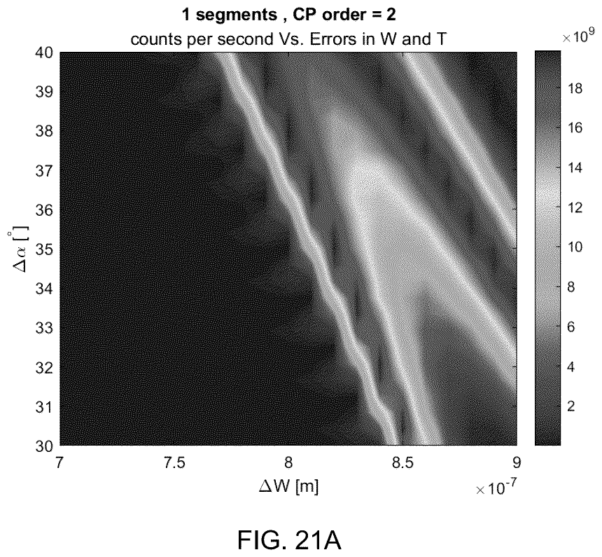

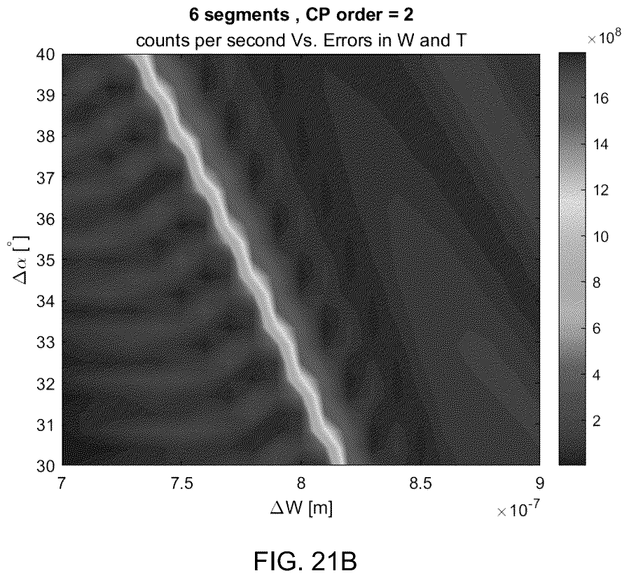

FIGS. 21A and 21B are two-dimensional color coded maps showing numbers of generated entangled pairs per second obtained using a trapezoid patterned waveguide as a function of deviation from the waveguide's wall angle and width, for a type-2 SPDC and for wavelength conversion of 785 nm to 1570 nm.

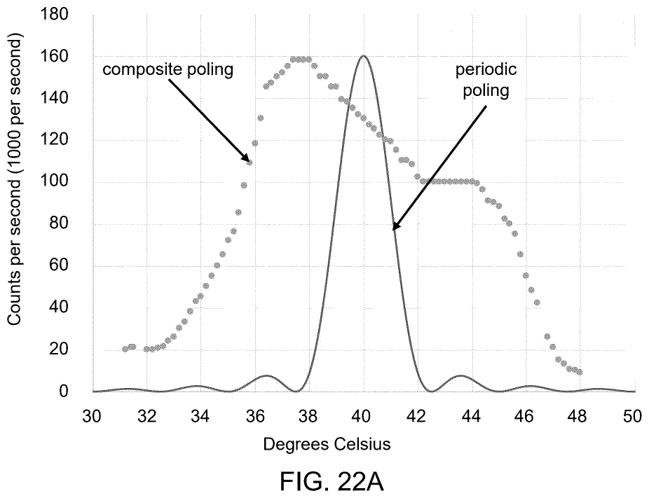

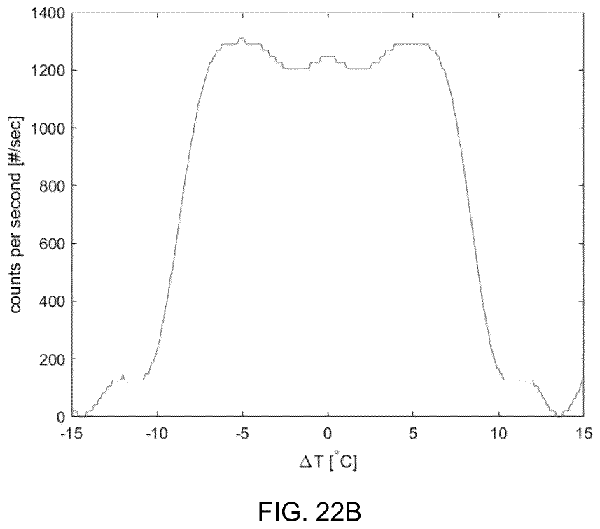

FIGS. 22A-B show simulation (FIG. 22B) and measurement (FIG. 22A) for the composite-poling crystal 10 of the present embodiments. The parameter triplet of crystal 10 are listed in Table 1, crystal II. Shown is count-rate as a function of the temperature. The full width at 90% of maximal count rate was 0.7 for crystal 34 and 2.7 for crystal 10. The full width at 50% of maximal count rate was 1.9 for crystal 34 and 10.2 for crystal 10.

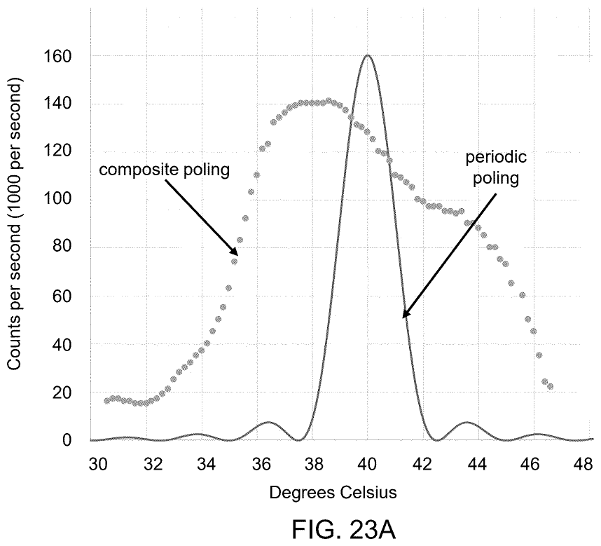

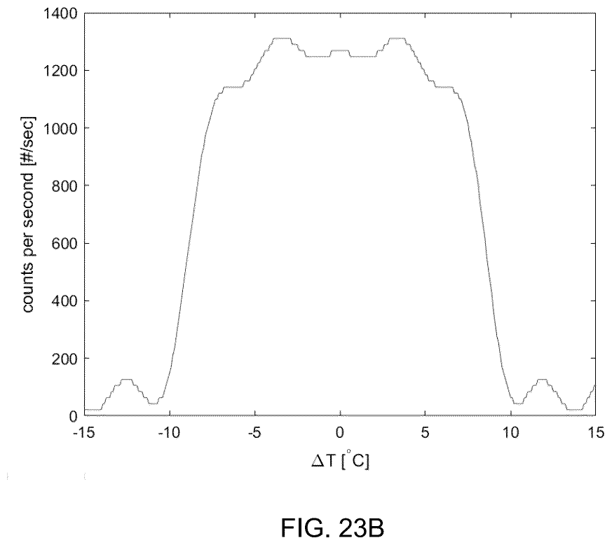

FIGS. 23A-B show simulation (FIG. 23B) and measurement (FIG. 23A) for the periodic poling crystal 34 and the composite-poling crystal 10 of the present embodiments. The parameter triplet of crystal 10 are listed in Table 1, crystal VI. Shown is count-rate as a function of the temperature. The full width at 90% of maximal count rate was 0.7 for crystal 34 and 3.6 for crystal 10. The full width at 50% of maximal count rate was 1.9 for crystal 34 and 10 for crystal 10.

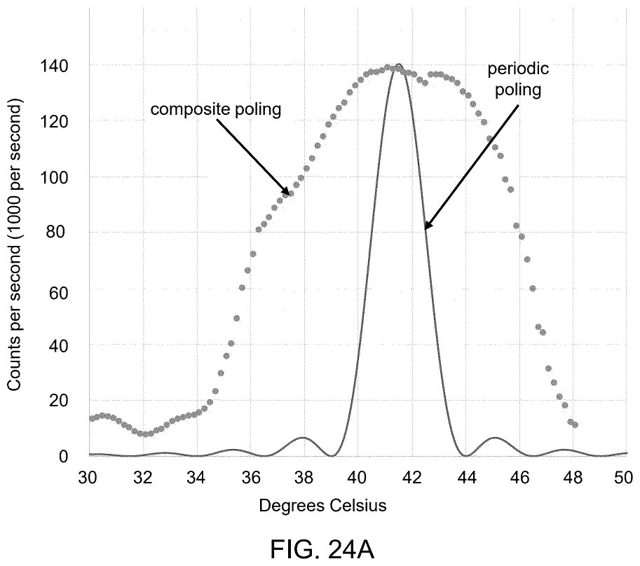

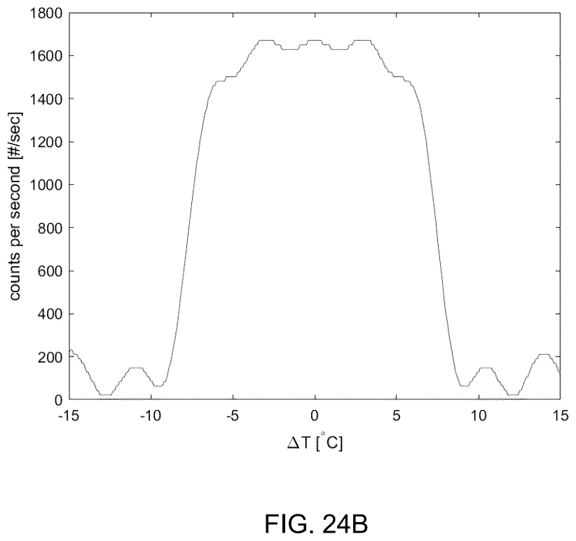

FIGS. 24A-B show simulation (FIG. 24B) and measurement (FIG. 24A) for the composite-poling crystal 10 of the present embodiments. The parameter triplet of crystal 10 are listed in Table 1, crystal VI. Shown is count-rate as a function of the temperature. The full width at 90% of maximal count rate was 0.7 for crystal 34 and 5 for crystal 10. The full width at 50% of maximal count rate was 1.9 for crystal 34 and 10.3 for crystal 10.

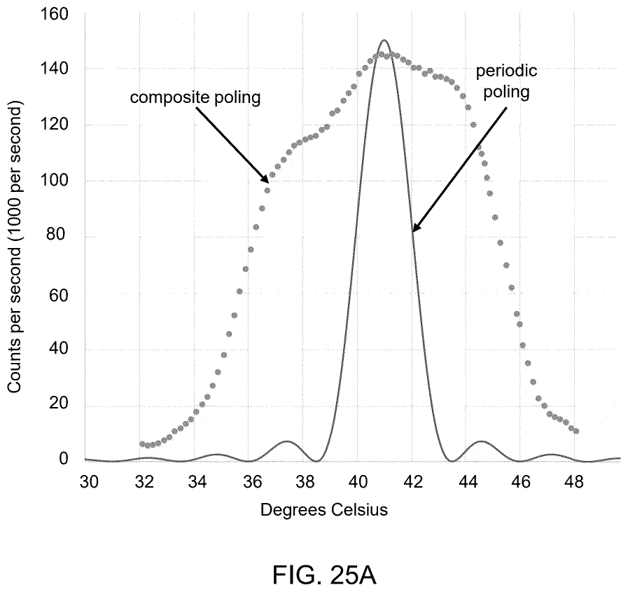

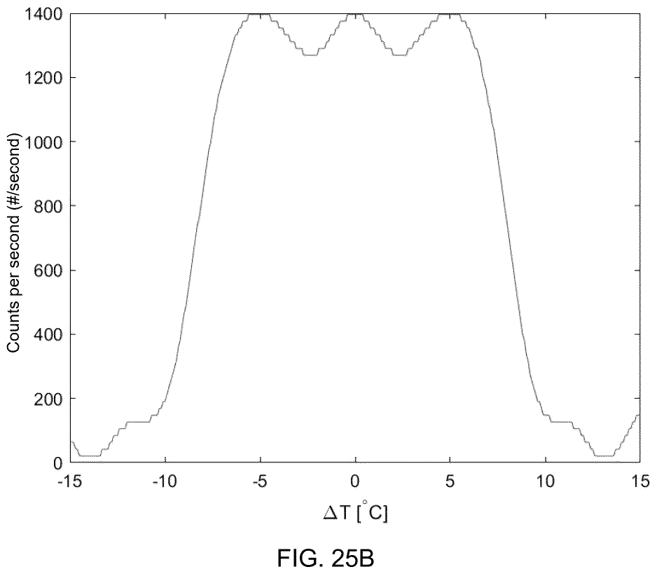

FIGS. 25A-B show simulation (FIG. 25B) and measurement (FIG. 25A) for the composite-poling crystal 10 of the present embodiments. The parameter triplet of crystal 10 are listed in Table 1, crystal VIII. Shown is count-rate as a function of the temperature. The full width at 90% of maximal count rate was 0.7 for crystal 34 and 4.3 for crystal 10. The full width at 50% of maximal count rate was 1.9 for crystal 34 and 9.4 for crystal 10.

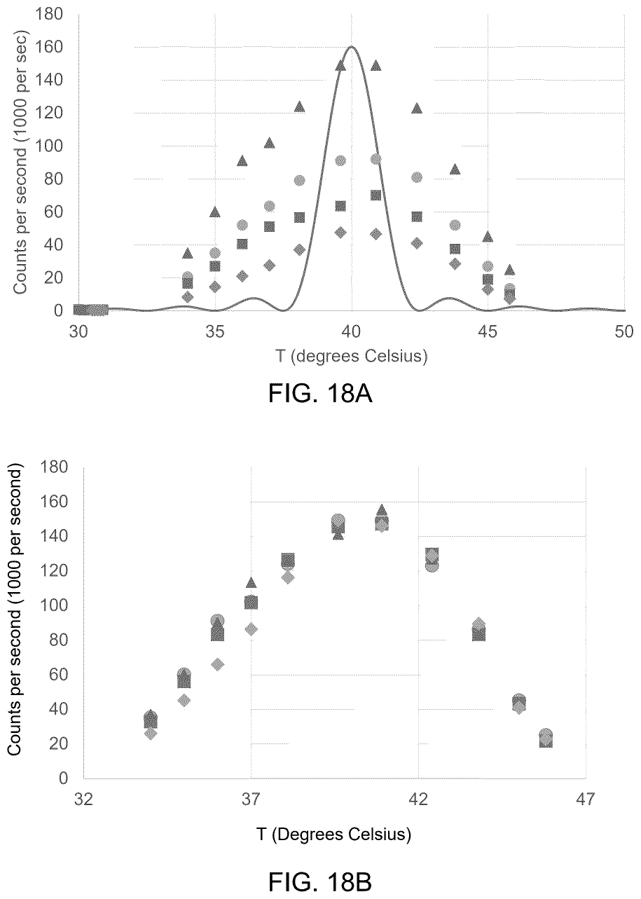

Experiments were also directed to investigate the performances of the crystal of the present embodiments when pumped by input pump beams of different power. In these experiments a variable neutral density filter was placed before the translation stage with the crystal and the different pump powers were imposed by changing the angle of the neutral density filter. The results are depicted in FIGS. 18A and 18B, which show count-rate as a function of the temperature with different input pump power for the composite-poling crystal 10 of the present embodiments. The crystal was a Raicol 2 crystal (Raicol Crystals Ltd) and the parameter triplet of crystal 10 are listed in Table 1, crystal VI. The data shown in FIG. 18B was obtained from the data shown in FIG. 18A by accounting for noise and normalizing to the same maximal value. In FIG. 18A triangles correspond to pump power of 72 mW, full circles correspond to 51 mW, squares correspond to 38 mW, and rhombuses correspond to 23 mW. In FIG. 18B, triangles correspond to 38 mW, full circles correspond to 72 mW, squares correspond to 51 mW, and rhombuses correspond to 23 mW.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

[1] Andon A. Rangelov, Nikolay V. Vitanov, and Germano Montemezzani. Robust and broadband frequency conversion in composite crystals with tailored segment widths and χ⁽²⁾ nonlinearities of alternating signs. Optics letters, 39(10):2959-2962, 2014.
[2] Yonathan Erlich, Andon A. Rangelov, Germano Montemezzani, and Haim Suchowski. Robust, efficient, and broadband shg of ultrashort pulses in composite crystals. Optics letters, 44(15):3837-3840, 2019.
[3] A. J Shaka and Alexander Pines. Symmetric phase-alternating composite pulses. Journal of Magnetic Resonance (1969), 71(3):495-503, 1987.
[4] Mouhamad Al-Mahmoud, Andon A. Rangelov, Virginie Coda, and Germano Monte-mezzani. Segmented composite optical parametric amplification. Applied Sciences, 10(4):1220, 2020.
[5] Elica Kyoseva, Hadar Greener, and Haim Suchowski. Detuning-modulated composite pulses for high-fidelity robust quantum control. Physical Review A, 100(3):032333, 2019.
[6] Moshe Katzman, Yonatan Piasetzky, Evyatar Rubin, Ben Barenboim, Maayan Priel, Muhammad Erew, Avi Zadok, and Haim Suchowski. Robust directional couplers for state manipulation in silicon photonic-integrated circuits. Journal of Lightwave Technology, pages 1-1, 2022.
[7] Yuval Reches, Elazar Elias, and Haim Suchowski. Detuning modulated composite segments for robust optical frequency conversion. Journal of Physics B: Atomic, Molecular and Optical Physics, 55:194002, 10 2022.
[8] W. Joosen, Pierre Agostini, Guillaume Petite, Jean-Paul Chambaret, and Andre An-tonetti. Broadband femtosecond infrared parametric amplification in β-bab 2 o 4. Optics letters, 17(2):133-135, 1992.
[9] G. M. Gale, M. Cavallari, T. J Driscoll, and Fran,cois Hache. Sub-20-fs tunable pulses in the visible from an 82-mhz optical parametric oscillator. Optics letters, 20(14):1562-1564, 1995.
[10] G. M. Gale, F. Hache, and M. Cavallari. Broad-bandwidth parametric amplification in the visible: femtosecond experiments and simulations. IEEE Journal of Selected Topics in Quantum Electronics, 4(2):224-229, 1998.
[11] Bruno E. Schmidt, Nicolas Thir\acute{ }e, Maxime Boivin, Antoine Laram\acute{ }ee, F. Poitras, Guy Lebrun, Tsuneyuki Ozaki, Heide Ibrahim, and Fran,cois L\acute{ }egar\acute{ }e. Frequency domain optical parametric amplification. Nature communications, 5(1):3643-3643, 2014.
[12] Stephen E. Harris. Chirp and compress: toward single-cycle biphotons. Physical review letters, 98(6):063602-NA, 2007.
[13] Mathieu Charbonneau-Lefort, Bedros Afeyan, and Martin M. Fejer. Optical parametric amplifiers using nonuniform quasi-phase-matched gratings. ii. space-time evolution of light pulses. Journal of the Optical Society of America B, 25(5):680-697, 2008.
[14] Mathieu Charbonneau-Lefort, Bedros Afeyan, and Martin M. Fejer. Optical parametric amplifiers using chirped quasi-phase-matching gratings i: practical design formulas. Journal of the Optical Society of America B, 25(4):463-480, 2008.
[15] Martin M. Phillips, Christopher R.; Fejer. Adiabatic optical parametric oscillators: steady-state and dynamical behavior. Optics express, 20(3):2466-2482, 2012.
[16] Christopher R. Phillips, Carsten Langrock, Derek Chang, Yu-Wei Lin, Lukas Gallmann, and Martin M. Fejer. Apodization of chirped quasi-phasematching devices. Journal of the Optical Society of America B, 30(6):1551-1568, 2013.
[17] A. Yariv and P. Yeh. Photonics: Optical Electronics in Modern Communications. Oxford series in electrical and computer engineering. Oxford University Press, 2007.
[18] R. W. Boyd. Nonlinear Optics. Elsevier Science, 2020.
[19] Robert L. Baumgartner, R.; Byer. Optical parametric amplification. IEEE Journal of Quantum Electronics, 15(6):432-444, 1979.
[20] Ray Levitt, Malcolm H.; Freeman. Nmr population inversion using a composite pulse. Journal of Magnetic Resonance (1969), 33(2):473-476, 1979.
[21] A. J. Shaka. Composite pulses for ultra-broadband spin inversion. Chemical Physics Letters, 120(2):201-205, 1985.
[22] Malcolm H. Levitt. Composite pulses. Progress in Nuclear Magnetic Resonance Spectroscopy, 18(2):61-122, 1986.
[23] Malcolm H. Levitt. Short perspective on “nmr population inversion using a composite pulse” by m. h. levitt and r. freeman [j. magn. reson. 33 (1979) 473-476]. Journal of Magnetic Resonance, 213, 2011.
[24] Michael H. Freedman. Quantum computation and the localization of modular functors. Foundations of Computational Mathematics, 1(2):183-204, 2001.
[25] Ferdinand Schmidt-Kaler, Hartmut H\ddot{ }affner, M. Riebe, S. Gulde, G. P. T. Lancaster, T. Deuschle, Christoph Becher, Christian F. Roos, Ju\ddot{ }rgen Eschner, and Rainer Blatt. Realization of the cirac-zoller controlled-not quantum gate. Nature, 422(6930):408-411, 2003.
[26] Nuala Timoney, V. Elman, Steffen J. Glaser, C. Weiss, M. Johanning, W. Neuhauser, and Chr. Wunderlich. Error-resistant single-qubit gates with trapped ions. Physical Review A, 77(5):052334-NA, 2008.
[27] Boyan T. Torosov, St\acute{ }ephane Gu\acute{ }erin, and Nikolay V. Vitanov. High-fidelity adiabatic passage by composite sequences of chirped pulses. Physical review letters, 106(23):233001-NA, 2011.
[28] Boyan T. Torosov, Elica Kyoseva, and Nikolay V. Vitanov. Composite pulses for ultrabroad-band and ultranarrow-band excitation. Physical Review A, 92(3):033406-NA, 2015.
[29] Boyan T. Torosov, St\acute{ }ephane Gu\acute{ }erin, and Nikolay V. Vitanov. High-fidelity adiabatic passage by composite sequences of chirped pulses. Physical Review Letters, 106:233001, 6 2011.
[30] Genko T. Genov, Daniel Schraft, Thomas Halfmann, and Nikolay V. Vitanov. Correction of arbitrary field errors in population inversion of quantum systems by universal composite pulses. Physical Review Letters, 113:043001, 7 2014.
[31] Nikolay V. Torosov, Boyan T.; Vitanov. Robust high-fidelity coherent control of two-state systems by detuning pulses. Physical Review A, 99(1):013424-NA, 2019.
[32] Boyan T. Torosov and Nikolay V. Vitanov. Experimental demonstration of composite pulses on ibm's quantum computer, 2 2022.
[33] Sourabh Katoch, Sumit Singh Chauhan, and Vijay Kumar. A review on genetic algorithm: past, present, and future. Multimedia Tools and Applications, 80:8091-8126, 2 2021.
[34] Kiyoshi Kato and Eiko Takaoka. Sellmeier and thermo-optic dispersion formulas for ktp. Applied Optics, 41:5040, 8 2002.
[35] Jacques Mangin, Gr\acute{ }egory Gadret, and Gabriel Mennerat. Dispersion and temperature dependence of thermo-optic coefficients of optical materials over their whole transparency range: vectorial formalism and application to KTiOPO4. In Angela Duparr\acute{ }e and Roland Geyl, editors, Optical Fabrication, Testing, and Metrology III, volume 7102 of Society of Photo-Optical Instrumentation Engineers (SPIE) Conference Series, page 71020 W, 9 2008.
[36] R. Hanbury Brown and R. Q. Twiss. Lxxiv. a new type of interferometer for use in radio astronomy. The London, Edinburgh, and Dublin Philosophical Magazine and Journal of Science, 45(366):663-682, 1954.
[37] R. HANBURY BROWN and R. Q. TWISS. Correlation between photons in two coherent beams of light. Nature, 177:127-129, 1 1956.
[38] C. K. Hong, Z. Y. Ou, and L. Mandel. Measurement of subpicosecond time intervals between two photons by interference. Phys. Rev. Lett., 59:2044-2046, November 1987.

1. A nonlinear crystal for generating pairs of entangled photons from a pump photon having a pump intensity, the crystal comprising a plurality of segments arranged along an axis, each segment being characterized by a parameter triplet comprising, a mismatch parameter, Δk, a coupling parameter, κ, and a length, z, of said segment;
wherein an ordered multiplication of SU(1,1) matrices, each corresponding to one of said segment and being composed of hyperbolic or harmonic functions of a respective parameter triplet Δk, κ, z, defines an overall SU(1,1) matrix describing sequential production of the pairs of entangled photons along said axis.

2. The nonlinear crystal of claim 1, wherein an absolute value of each element of said overall SU(1,1) matrix has at least a first order variation less than a predetermined threshold.

3. The nonlinear crystal of claim 1, wherein an absolute value of each element of said overall SU(1,1) matrix has n-order variations less than a predetermined threshold, for any integer n less than M, wherein M is at least 3.

4. The nonlinear crystal according to claim 1, wherein at least one of said segment is poled with a poling period selected based on said mismatch parameter.

5. (canceled)

6. The nonlinear crystal according to claim 4, wherein a domain size of said poled segment is an integer multiplication of a predetermined minimal domain size parameter.

7. (canceled)

8. The nonlinear crystal according to claim 6, wherein said minimal domain size parameter is from about 1 nm to about 100 nm, e.g., about 25 nm.

9. (canceled)

10. The nonlinear crystal according to claim 1, wherein each of at least two of said segments is made of more than one material selected to ensure a phase-mismatch between adjacent segments.

11. (canceled)

12. The nonlinear crystal according to claim 1, wherein at least two of said segments are maintained at different temperatures selected to ensure a phase-mismatch between adjacent segments.

13. (canceled)

14. The nonlinear crystal according to claim 1, wherein a length of each segment is at least 1000 nm.

15. (canceled)

16. The nonlinear crystal according to claim 1, wherein said mismatch parameters of said segments form an antisymmetric sequence of mismatch parameters.

17. (canceled)

18. The nonlinear crystal according to claim 1, wherein said mismatch parameters of said segments form an interleaved sequence of mismatch parameters.

19. (canceled)

20. The nonlinear crystal according to claim 18, wherein adjacent mismatch parameters of said interleaved sequence are opposite in sign.

21. (canceled)

22. The nonlinear crystal according to claim 18, wherein each odd index element of said interleaved sequence is equal in magnitude and opposite in sign to an even index element immediately following said odd index element.

23. (canceled)

24. The nonlinear crystal according to claim 1, wherein for each of said segments, said mismatch parameter and said coupling parameter are selected such that a respective SU(1,1) matrix is composed of harmonic functions of a respective parameter triplet.

25. (canceled)

26. The nonlinear crystal according to claim 1, wherein an overall efficiency of said production of said pairs is at most 50% of an efficiency of producing pairs of entangled photons from a perfectly phase matched nonlinear crystal having the same length as the nonlinear crystal and using said pump intensity.

27. (canceled)

28. A nonlinear crystal for generating pairs of entangled photons from a pump photon having a pump intensity, the crystal comprising a plurality of segments arranged along an axis, such that a phase mismatch Δk is substantially piecewise constant as a function of a position along said axis.

29. A method of generating pairs of entangled photons, comprising directing a beam of pump photons having a pump intensity onto the nonlinear crystal according to claim 1.

30. An optical system comprising nonlinear crystal according to claim 1, wherein said optical system is selected from the group consisting of a light emission system, a communication system, a quantum cryptograph system, a quantum computer, a quantum metrology inspection system, and a quantum simulation system.

31-36. (canceled)
